(19) United States
(12) Patent Application Publication
(10) Pub. No.: US 2003/0218772 A1
(43) Pub. Date: Nov. 27, 2003

(54) Image printing system and printing method therefor, image printing apparatus and image printing method therefor, printing medium unit, information delivering apparatus and information delivering method therefor, and program

(76) Inventors: Koji Maekawa, Kyoto (JP); Katsuyuki Inage, Kyoto (JP); Tadasu Maeda, Tokyo (JP); Naoto Shiki, Osaka (JP)

Correspondence Address: DICKSTEIN SHAPIRO MORIN & OSHINSKY LLP, 2101 L STREET NW, WASHINGTON, DC, 20037-1526, US

(21) Appl. No.: 10/400,490

(22) Filed: Mar. 28, 2003

(30) Foreign Application Priority Data
Apr. 4, 2002 (JP) 2002-102422
Jun. 25, 2002 (JP) 2002-183783

(51) Int. Cl. B41B 1/00; G06F 15/00; H04N 1/23

(52) U.S. Cl. 358/1.15; 358/302

(57) ABSTRACT

The invention aims to enable a plurality of users to perform photography suited to the tastes of the respective users. An image printing apparatus and a server are connected to one another via a network. The image printing apparatus transmits transmission information for requesting delivery of predetermined contents (for example, photographed pose image data, BGM data and narration data), to the server via the network. The server delivers reception information including the contents requested by the transmission information to the image printing apparatus via the network. The invention is applicable to, for example, an image printing apparatus represented by Print Club (trademark).

### BACKGROUND OF THE INVENTION

1. Field of the Invention

The present invention generally relates to an image printing system, an image printing apparatus, an image printing method, a printing medium unit, an information delivering apparatus, and an information delivering method, as well as a program, and more particularly, to an image printing system, an image printing apparatus, an image printing method, a printing medium unit, an information delivering apparatus, and an information delivering method, as well as a program all of which are constructed to be capable of effecting photography having different amusement effects suited to the tastes of a plurality of different users.

2. Description of the Related Art

An image printing apparatus (for example, Pring Club (trademark)) has heretofore been known which is constructed to photograph a user, synthesize a photographed image of the user with a predetermined frame, print the synthesized image on seal paper or the like, and output the printed seal paper or the like.

For example, JP-A-2000-78501 discloses an image printing apparatus capable of using limited-edition types of frames. In the case where the image printing apparatus uses a limited-edition type of frame, when a predetermined period elapses, the image printing apparatus erases a frame stored in its internal memory until that point of time, downloads a new frame from a network, and stores the new frame into the internal memory.

JP-A-10-274806 discloses an image printing apparatus constructed to print, in addition to a photographed image, an image of a home page on the Internet onto seal paper.

As is apparent from the above description, because of the nature of the image printing apparatus, there has been a demand for an image printing apparatus which is rich in amusement effects, and this trend has recently been becoming stronger and stronger.

Namely, the number of users who not only desire seals rich in individuality, but also desire to enjoy the process of printing such seals is increasing year after year (the process of printing the seals includes a series of processes through which a user puts a coin into the image printing apparatus, causes the image printing apparatus to photograph the user himself/herself, applies image processing such as scribbling to a photographed image of the user, causes the image printing apparatus to print onto a seal the image of the user to which the image processing is applied, and causes the seal to be outputted from the image printing apparatus (such a series of processes is hereinafter referred to as seal printing play).

However, the related art image printing apparatus disclosed in the above-cited two documents can provide seals rich in individuality, but have the problem that it is difficult to provide seal printing play rich in individuality.

Namely, while a user is performing seal printing play, the image printing apparatus causes its display to display, as a supplementary effect, images for introducing photographic poses or explaining the seal printing play, or causes a speaker to output sounds such as Background Music (hereinafter BGM) or narration, as a supplementary effect.

However, in many types of related-art image printing apparatus, contents such as those images and sounds (such contents that are used as supplementary effects during seal printing play will be hereinafter referred to supplementary effect contents) have been stored as software in the memories of the apparatus. Namely, the related arts have the problem that since fixed (preset) contents are used as the supplementary effect contents, individual users cannot perform seal printing play while seeing or hearing supplementary effect contents suited to their individual tastes.

The supplementary effect contents are contents depending on fashions or trends, and therefore rapidly change. Accordingly, the supplementary effect contents need to be frequently updated, but the updating of the supplementary effect contents has heretofore been performed by means of a recording medium such as a CD-ROM (Compact Disk-Read Only Memory) on which the supplementary effect contents are recorded. In this case, it takes a long time to prepare recording media on which new supplementary effect contents are recorded, and distribute the recording media to individual image printing apparatus which are disposed at various locations. Also, since the number of supplementary effect contents recordable on each recording medium is limited, there is the problem that it is difficult to frequently perform updating of supplementary effect contents.

### SUMMARY OF THE INVENTION

The invention has been made in view of the above-described problems, and aims to enable a plurality of users to perform photography having amusement effects suited to the tastes of the respective users. An image printing system according to the invention includes: an image printing apparatus having a photographing unit for photographing a subject and a printing unit for printing an image of the subject photographed by the photographing unit; an information delivering apparatus for delivering information to the image printing apparatus, the image printing apparatus and the information delivering apparatus being connected to one another via a network. The image printing apparatus requests the information delivering apparatus via the network to deliver the information to the image printing apparatus, and the information delivering apparatus delivers the information requested by the image printing apparatus to the image printing apparatus via the network.

In an exemplary image printing system according to the invention, when the image printing apparatus and the information delivering apparatus are connected to one another via the network, the image printing apparatus requests delivery of information from the information delivering apparatus, and the information is delivered to the image printing apparatus via the network by the information delivering apparatus. Accordingly, the image printing apparatus can consistently provide a user with the latest information suited to the taste of the user.

A network may include the Internet or the like, and each of the image printing apparatus and the information delivering apparatus is made of an information processing apparatus having, for example, a Central Processing Unit (CPU). A camera according to the invention may include for example, a Charge Coupled Device (CCD) camera, and the printing unit is made of, for example, a printer.

In addition, according to the invention, the image printing apparatus is capable of outputting information delivered from the information delivering apparatus independently of processing performed by the photographing unit and the printing unit, during a period when the image printing apparatus causes the photographing unit to photograph the subject and causes the printing unit to print an image of the subject photographed by the photographing unit.

Accordingly, the user can consistently perform seal printing play with the image printing apparatus by using the latest information (for example, supplementary effect contents) suited to the taste of the user. The user can cause the image printing apparatus to execute a series of processing steps to photograph the user himself/herself by means of the photographing unit and printing an image of the user by means of the printing unit.

An exemplary image printing method according to the invention may include the following steps: an image printing apparatus having a photographing unit for photographing a subject and a printing unit for printing an image of the subject photographed by the photographing unit; and an information delivering apparatus for delivering information to the image printing apparatus, the image printing apparatus and the information delivering apparatus being connected to one another via a network. The image printing method may include the steps of: causing the image printing apparatus to request the information delivering apparatus via the network to deliver the information to the image printing apparatus; and causing the information delivering apparatus to deliver the information requested by the image printing apparatus to the image printing apparatus via the network.

In the image printing method for the image printing system according to the invention, when the image printing apparatus and the information delivering apparatus are connected to one another via a network, the image printing apparatus requests delivery of information from the information delivering apparatus and the information is delivered to the image printing apparatus via a network by the information delivering apparatus. Accordingly, the image printing apparatus can consistently provide the user with the latest information suited to the taste of the user.

An exemplary image printing apparatus according to the invention may include: a photographing unit for photographing a subject; a printing unit for printing an image of the subject photographed by the photographing unit; a creating unit for creating request information for requesting delivery of information from an information delivering apparatus connected to the image printing apparatus via a network; a transmitting unit for transmitting the request information created by the creating unit to the information delivering apparatus via the network; a receiving unit for receiving via the network the information which is transmitted by the information delivering apparatus and corresponds to the request information transmitted by the transmitting unit; and an outputting unit for outputting the information received by the receiving unit.

In an image printing apparatus according to an embodiment of the invention, the request information for requesting delivery of information from the information delivering apparatus, which is connected to the image printing apparatus via the network, is created and is transmitted to the information delivering apparatus via the network. When information corresponding to the request information is transmitted by the information delivering apparatus, the information is received by the image printing apparatus via the network. Then, the received information is outputted as required. Accordingly, the image printing apparatus can consistently provide the user with the latest information suited to the taste of the user.

The photographing unit may include, for example, a CCD camera or any other camera, the printing unit may include, for example, a printer, the creating unit may include, for example, a CPU, the transmitting unit and the receiving unit may include, for example, a modem, and the outputting unit may include, for example, a Cathode-Ray Tube (CRT) or a speaker.

The outputting unit is constructed to be capable of outputting the information received by the receiving unit, independently of processing performed by the photographing unit and the printing unit, during a period when the subject is photographed by the photographing unit and an image of the subject photographed by the photographing unit is printed by the printing unit. Accordingly, the user can consistently perform seal printing play by using the latest information suited to the taste of the user.

The creating unit creates the request information for requesting delivery of image data, and the outputting unit may have a display unit for displaying an image corresponding to the image data which is received by the receiving unit and corresponds to the request information. In addition, the image data may be image data corresponding to an image different from the image to be printed by the printing unit. Accordingly, it is possible to timely provide image data such as popular photographic poses. The display unit is made of, for example, a CRT.

The image data may include, for example, image data connected to a kinetic image. Furthermore, an image corresponding to the image data may include an image for publicizing a predetermined commercial item, among other images.

A manager or other operator of the information delivering apparatus which delivers the contents of the kinetic image may collect advertising expenses from a seller that sells a commercial item. Accordingly, it is possible to create and deliver the contents of the kinetic image at reduced creation costs, since the manager of the information delivering apparatus can inexpensively deliver the contents of the kinetic image, the contents of the kinetic image can be updated without spending expenses and time, and can consistently provide the latest kinetic image contents for the user. A user can consistently perform seal printing play using the latest contents, and can also assume a pose according to the kinetic image and photograph himself/herself with the pose, whereby the user can enjoy active and new seal printing play which is amusing to the user.

In addition, the creating unit creates the request information for requesting delivery of sound data, and the outputting unit may have a sound outputting unit for outputting a sound corresponding to the sound data which is received by the receiving unit and corresponds to the request information. Accordingly, it is possible to timely provide sound data such as the latest BGM and narration. The sound outputting unit may include, for example, a speaker or other sound outputting device.

Furthermore, the image printing apparatus includes an executing unit for executing a computer program which is received by the receiving unit and corresponds to request information for requesting the computer program. The creating unit creates the request information which the outputting unit outputs and when the computer program is executed by the executing unit, information corresponding to a function is executed by the computer program.

Accordingly, the image printing apparatus can timely use the latest version of application software or the like for reproducing the latest contents such as an image, BGM or a narration. In other words, the user can promptly perform seal printing play using contents which can be reproduced by only the latest version of application software. The executing unit may include, for example, a CPU.

The image printing apparatus further includes a storage unit for storing the information received by the receiving unit. The creating unit is constructed to be capable of creating, when a predetermined condition is satisfied, the request information for requesting delivery of the information not yet stored in the storage unit. For example, the creating unit may create, when the image printing apparatus is activated, the request information for requesting delivery of the information not yet in the storage unit. Accordingly, the latest information can be stored in the storage unit each time the image printing apparatus is activated. The storage unit may include, for example, a hard disk or a Random Access Memory (RAM).

Each time a predetermined time elapses, the creating unit can create the request information for requesting delivery of the information not yet stored in the storage unit. Accordingly, the latest information can be stored in the storage unit even if the image printing apparatus is placed in an activated state for a long time.

The image printing apparatus further includes a specifying unit for specifying the information delivered by the information delivering apparatus. The specifying unit is constructed to be capable of creating the request information for requesting delivery of the information specified by the specifying unit. Accordingly, a user can consistently use the desired information to perform seal printing play. The specifying unit may include, for example, a touch pen and a touch panel or a hardware button or other similar means.

In addition, the information delivered by the information delivering apparatus has a unique identifier (ID), and the creating unit creates the request information including the ID corresponding to the information for requesting delivery, and the receiving unit receives the information corresponding to the ID transmitted by the information delivering apparatus and included in the request information. Accordingly, even in the case where a multiplicity of pieces of information are stored in the information delivering apparatus, the user can easily and positively acquire the desired information.

In addition, the creating unit may create request information for requesting the information to be delivered to an information processing apparatus possessed by a user. The information requested by the request information may include, for example, sound data corresponding to a sound previously outputted to the user by the outputting unit, and the information may be used by a mobile telephone as sound data corresponding to a sound indicative of reception of an incoming call. Accordingly, a manager of the information delivering apparatus can automatically acquire the mail address or the telephone number of a mobile telephone possessed by the user using the image printing apparatus.

Accordingly, the manager may transmit a questionnaire mail to acquired mail addresses (the mail addresses of the mobile telephones possessed by the users) to carry out a questionnaire survey as to the tastes of the users, whereby the manager itself adds up the users' answers to the questionnaire and can use the results for the development of products. Otherwise, the manager may receive a request for a questionnaire from another company, acquire responses to the questionnaire by using questionnaire mails as described above, and provide the acquired responses for the company, thereby obtaining a profit. An exemplary questionnaire is not limited to particular contents, and may ask respondents to select likes and dislikes from among a plurality of designs of clothes presented to the respondents or may ask the respondents to rate the designs or any other questions.

Further, the manager of the information delivering apparatus may deliver an advertisement for the commercial item to acquired mail addresses and collect an advertising fee from a seller that sells a predetermined commercial item. The manager of the image printing apparatus may make a predetermined contract with the manager of the information delivering apparatus as to the service of providing the information delivering apparatus with the addresses possessed by users using the image printing apparatus and as to the service of delivering information from the information delivering apparatus to the image printing apparatus. In this case, the manager or the like of the image printing apparatus can consistently provide the latest BGM for users without spending expenses and time to update the contents. Accordingly, the users can consistently use the latest BGM to perform seal printing play, and further can use the BGM as a mobile-telephone musical ring tones for the mobile telephones possessed by the users themselves, for example.

The image printing apparatus may further include a reading unit for reading identification information to identify a printing medium. The printing medium is fitted into the image printing apparatus and an image of a subject printed by the printing unit. The printing medium unit according to the invention is constructed to store the printing medium on which the image of the subject is to be printed by the printing unit of the image printing apparatus, and is capable of holding the identification information to be read by the reading unit. A printing controlling unit controls printing on the printing medium on the basis of a result read by the reading unit. The reading unit may include, for example, an ID tag reader/writer, and the printing controlling unit may include, for example, a CPU. Furthermore, the printing medium is a seal, and the image printing apparatus may also be a photography seal vending machine. Accordingly, when seal sheets are to be loaded into the image printing apparatus, seal sheets designated as those dedicated to the image printing apparatus can be correctly loaded.

An exemplary image printing method for an image printing apparatus according to the invention may also include: a creating step of creating request information for requesting delivery of information from an information delivering apparatus connected to the image printing apparatus via a network; a transmitting step of transmitting the request information created by processing of the creating step, to the information delivering apparatus via the network; a receiving step of receiving via the network the information which is transmitted by the information delivering apparatus and corresponds to the request information transmitted by processing of the transmitting step; and an outputting controlling step of controlling outputting of the information received by processing of the receiving step.

A first program causes a computer to execute the following exemplary steps: a creating step of creating request information for requesting delivery of information from an information delivering apparatus connected to the image printing apparatus via a network; a transmitting step of transmitting the request information created by processing of the creating step, to the information delivering apparatus via the network; a receiving step of receiving via the network the information which is transmitted by the information delivering apparatus and corresponds to the request information transmitted by processing of the transmitting step; and an outputting controlling step of controlling outputting of the information received by processing of the receiving step.

In the image printing method for the image printing apparatus according to the invention and in the first program, the request information for requesting delivery of information from the information delivering apparatus connected to the image printing apparatus via the network is created, and is transmitted to the information delivering apparatus via the network. When information corresponding to the request information is transmitted by the information delivering apparatus, the information is received by the image printing apparatus. Then, for example during a period when a subject is photographed and an image of the photographed subject is printed, the received information is outputted as required. Accordingly, the image printing apparatus can consistently provide a user with the latest information suited to the taste of the user.

An exemplary information delivering apparatus according to the invention may include: a storage unit for storing information delivered to the image printing apparatus; a receiving unit for receiving via a network request information for requesting delivery of information, the request information being transmitted by the image printing apparatus; an acquiring unit for acquiring information corresponding to the request information received by the receiving unit, from the information stored in the storage unit; and a transmitting unit for transmitting the information acquired by the acquiring unit to the image printing apparatus via the network.

In the information delivering apparatus according to the invention, in the case where the request information for requesting delivery of information is transmitted by the image printing apparatus and is received by the information delivering apparatus via a network, information corresponding to the received request information is acquired from the information stored in the storage unit, and is transmitted to the image printing apparatus via the network. The storage unit may include, for example, a hard disk or a RAM, the receiving unit and the transmitting unit may include, for example, a modem, and the acquiring unit may include, for example, a CPU. The information may be image data corresponding to an image different from an image to be printed by the printing unit of the image printing apparatus. Accordingly, the information delivering apparatus can consistently deliver to the image printing apparatus the latest information suited to the tastes of users using the image printing apparatus and it is possible to timely provide image data such as popular photographic poses.

In addition, the image data may be image data corresponding to a kinetic image. Furthermore, an image corresponding to the image data may include, for example, an image for publicizing a predetermined commercial item. A manager of the information delivering apparatus which delivers kinetic image contents may collect advertising expenses from a seller that sells the commercial item. It is therefore possible to create and deliver the kinetic image contents at reduced creation costs. Since the manager of the image printing apparatus can inexpensively deliver the kinetic image contents, the manager can update the kinetic image contents without spending expenses and time to update the kinetic image contents, and can consistently provide the latest kinetic image contents. Accordingly, a user can consistently perform seal printing play using the latest kinetic image contents, and can also assume a pose according to the kinetic image and photograph himself/herself with the pose, whereby the user can enjoy active and new seal printing play which is amusing to the user.

The information may also include sound data. Accordingly, it is possible to timely provide sound data such as the latest BGM or narration. The information may further include a computer program. Accordingly, it is possible to timely provide the image printing apparatus with the latest version of application software or the like for reproducing the latest contents (an image, BGM or a narration). In other words, a user can promptly perform seal printing play using contents which can be reproduced by only the latest version of application software.

The information stored in the storage unit has a unique identifier (ID), the receiving unit receives the request information including the ID corresponding to the information which is transmitted by the image printing apparatus and whose delivery is requested by the image printing apparatus. The acquiring unit acquires the information corresponding to the ID included in the request information received by the receiving unit from the information stored in the storage unit. Accordingly, even in the case where a multiplicity of pieces of information are stored in the storage unit, the user can easily and positively acquire the desired information.

In addition, the receiving unit receives the request information for requesting the information to be delivered to an information processing apparatus possessed by a user using the image printing apparatus. The acquiring unit acquires the information corresponding to the request information received by the receiving unit from the information stored in the storage unit. The transmitting unit can further transmit the information acquired by the acquiring unit to the information processing apparatus possessed by the user. If the information processing apparatus possessed by the user is a mobile telephone for example, and the information requested by the request information is sound data previously transmitted to the image printing apparatus by the transmitting unit and the information can be used by the mobile telephone as sound data corresponding to a sound indicative of reception of an incoming call.

Accordingly, this embodiment allows the manager of the information delivering apparatus to automatically acquire the mail address or the telephone number of a mobile telephone possessed by the user using the image printing apparatus. The manager may transmit a questionnaire mail to acquired mail addresses (the mail addresses of the mobile telephones possessed by users) to carry out a questionnaire survey as to the tastes of the users, whereby the manager may analyze the users' answers to the questionnaire and can use the results for the development of products. Otherwise, the manager may receive a request for a questionnaire from another company, acquire responses to the questionnaire by using questionnaire mails as described above, and provide the acquired responses to the company, thereby obtaining a profit. The questionnaire described above is not limited to particular contents, and may ask respondents to select likes and dislikes from among a plurality of designs of clothes presented to the respondents or may ask the respondents to rate the designs, for example.

Further, the manager or the like of the information delivering apparatus may deliver an advertisement for the commercial item to acquired mail addresses and collect an advertising fee from a seller that sells a predetermined commercial item.

A manager of the image printing apparatus may collaborate with a manager of the information delivering apparatus as to the service of providing the information delivering apparatus with the addresses possessed by users using the image printing apparatus and as to the service of delivering information from the information delivering apparatus to the image printing apparatus. In this example, the manager or the like of the image printing apparatus can consistently provide the latest BGM for users without spending expenses and time to update the contents. Accordingly, the users can consistently use the latest BGM to perform seal printing play, and further can use the BGM as mobile-telephone musical ring tones for the mobile telephones possessed by the users themselves.

Further, the information transmitted to a mobile telephone by the transmitting unit can be constructed to be disabled from being transmitted when the mobile telephone which has received the information is to transmit the information to another information processing apparatus. Accordingly, in a case where the information transmitted to the mobile telephone holds a copyright, the information can be prevented from being used free of charge by any party other than the possessor of the mobile telephone who is a valid user of the information (contents).

In addition, the information transmitted from the transmitting unit to the mobile telephone can be constructed so that in the case where the mobile telephone which has received the information transmits the information to another information processing apparatus, a user who uses the other information processing apparatus is charged a fee when the other information processing apparatus which has received the information uses the information. Accordingly, a user who possesses an information processing apparatus (such as a mobile telephone) other than a mobile telephone which is the first mobile telephone to receive the information is charged a fee for the information (contents), whereby it is possible to reliably protect the copyright of the information.

Information transmitted from the transmitting unit to the mobile telephone may be recorded on a recording medium to be fitted into the mobile telephone, and can be constructed so that in the case where the recording medium on which the information is recorded is fitted into another information processing apparatus, the information is disabled from being reproduced when the other information processing apparatus attempts to reproduce the information from the recording medium. Accordingly, the user of the mobile telephone cannot copy the information (contents) to another information processing device, whereby it is possible to reliably protect the copyright of the information.

An information delivering method for an information delivering apparatus according to the invention may include: a storage controlling step of controlling storage of information delivered to the image printing apparatus; a receiving step of receiving via the network request information for requesting delivery of information, the request information being transmitted by the image printing apparatus; an acquiring step of acquiring the information corresponding to the request information received by processing of the receiving step, from the information whose storage is controlled by processing of the storage controlling step; and a transmitting step of transmitting the information acquired by processing of the acquiring step to the image printing apparatus via the network.

A second embodiment program according to the invention causes a computer to execute: a storage controlling step of controlling storage of information delivered to the image printing apparatus; a receiving step of receiving via the network request information for requesting delivery of information, the request information being transmitted by the image printing apparatus; an acquiring step of acquiring the information corresponding to the request information received by processing of the receiving step, from the information whose storage is controlled by processing of the storage controlling step; and a transmitting step of transmitting the information acquired by processing of the acquiring step to the image printing apparatus via the network.

In this embodiment the information delivering method for the information delivering apparatus in the second program, when the request information for requesting delivery of information is transmitted by the image printing apparatus and is received by the information delivering apparatus via the network, information corresponding to the received request information is acquired from the information stored in the storage unit, and is transmitted to the image printing apparatus via the network. Accordingly, the information delivering apparatus can consistently deliver to the image printing apparatus the latest information suited to the tastes of users using the image printing apparatus.

### BRIEF DESCRIPTION OF THE DRAWINGS

The invention will become more readily appreciated and understood from the following detailed description of a preferred embodiment of the invention when taken in conjunction with the accompanying drawings, in which:

FIG. 1 shows an embodiment of an image printing system according to the invention;

FIG. 2 shows another embodiment of an image printing system according to the invention;

FIG. 3 is a perspective view showing an embodiment of an image printing apparatus of the image printing system shown in FIG. 1;

FIG. 4 is a schematic diagram of a system employing the image printing apparatus shown in FIG. 3;

FIG. 5 shows an embodiment of a server of the image printing system shown in FIG. 1;

FIG. 6 is a flowchart describing the processing of the image printing apparatus shown in FIG. 3;

FIG. 7 is a flowchart describing the details of the seal printing play processing shown in FIG. 6;

FIG. 8 is a flowchart describing the details of the seal printing play processing shown in FIG. 6;

FIG. 9 is a view showing a first example of an image on a display part of the image printing apparatus shown in FIG. 3;

FIG. 10 is a view showing a second example of an image displayed on the display part of the image printing apparatus shown in FIG. 3;

FIG. 11 is a view showing a third example of an image displayed on the display part of the image printing apparatus shown in FIG. 3;

FIG. 12 is a flowchart describing exemplary processing of the server shown in FIG. 5;

FIG. 13 is a flowchart showing the relationship between the image printing apparatus shown in FIG. 3 and the processing of the server shown in FIG. 5;

FIG. 14 is a flowchart showing the relationship between the image printing apparatus shown in FIG. 3 and the processing of the server shown in FIG. 5; and

FIG. 15 an embodiment of a business model supported by the image printing system shown in FIG. 2.

### DETAILED DESCRIPTION OF THE INVENTION

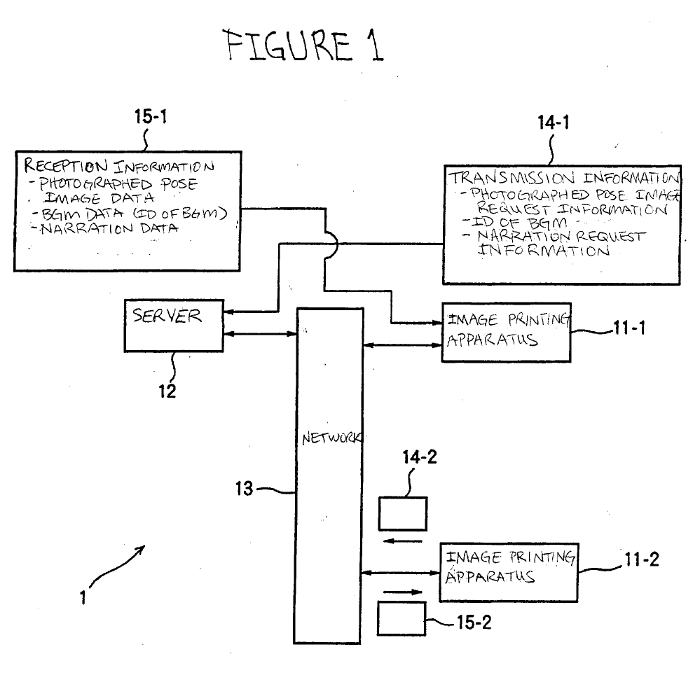

A first preferred embodiment of the invention will be described below in detail with reference to the accompanying drawings. FIG. 1 shows an example of an image printing system to which the invention is applied. In an image printing system 1, an arbitrary number of (in the example shown in FIG. 1, two) image printing apparatus 11-1 and 11-2 and a server 12 are connected to one another via a network 13. The image printing apparatus 11-1 generates transmission information 14-1 and transmits the transmission information 14-1 to the server 12 via a network 13.

In this example, the contents of the transmission information 14-1 may include, but are not limited to, information which requests delivery of supplementary effect contents. Specifically, in the example shown in FIG. 1, the transmission information 14-1 includes information (hereinafter referred to as photographed pose image request information) which requests delivery of image data corresponding to an image for explaining a predetermined photographed pose to a user (hereinafter referred to as photographed pose image data), an ID (identifier) previously assigned to the BGM (hereinafter referred to as an BGM-ID) for requesting sound data corresponding to predetermined BGM (hereinafter referred to as BGM data), and information (hereinafter referred to as narration request information) which requests delivery of sound data corresponding to predetermined narration (hereinafter referred to as narration data).

However, the transmission information 14-1 does not need to include all this set of information (the photographed pose image request information, the BGM-ID and the narration request information), and may include an arbitrary number of arbitrary pieces of information selected from this set of information. Furthermore, the transmission information 14-1 may also include information which requests delivery of information other than this set of information (the photographed pose image request information, the BGM-ID and the narration request information). For example, a computer program such as application software for reproducing the photographed pose image data, the BGM data and the narration data may be requested.

Similarly to the image printing apparatus 11-1, the image printing apparatus 11-2 generates transmission information 14-2 and transmits the transmission information 14-2 to the server 12 via the network 13. The network 13 is not limited to a particular type of network, and in this example, uses the Internet by way of example.

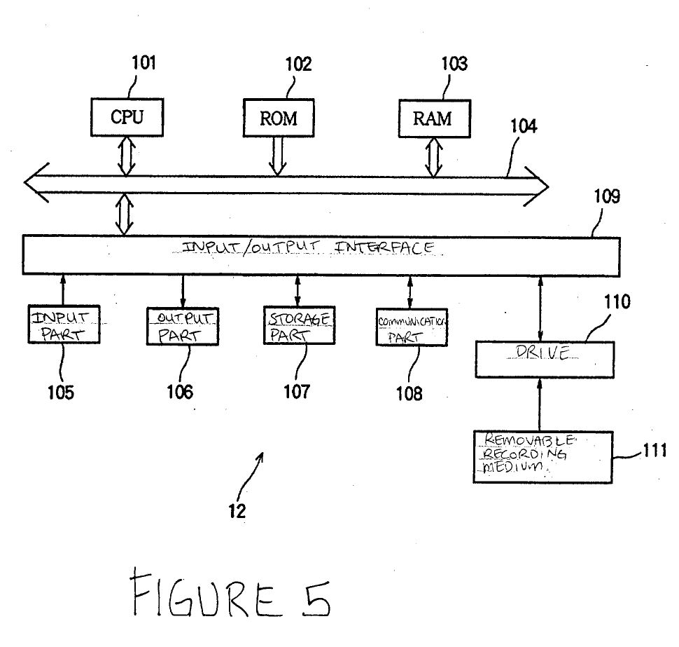

In this example, the server 12 stores the supplementary effect contents (in this example, a plurality of photographed pose image data, a plurality of BGM data or a plurality of narration data) to be delivered to the image printing apparatus 11-1 or the image printing apparatus 11-2. The server 12 may store supplementary effect contents in, for example, an internal memory (such as a storage part 107 which will be described later with reference to FIG. 5).

When the server 12 receives the transmission information 14-1 transmitted from the image printing apparatus 11-1 via the network 13, the server 12 reads the supplementary effect contents requested by the transmission information 14-1, from the plurality of supplementary effect contents stored in the internal memory, then incorporates the read supplementary effect contents into reception information 15-1. The server 12 then transmits or delivers the reception information 15-1 to the image printing apparatus 11-1 via the network 13.

In the example shown in FIG. 1, the reception information 15-1 includes the photographed pose image data corresponding to the photographed pose image request information of the transmission information 14-1, the BGM data (and the BGM-ID) corresponding to the ID of the BGM of the transmission information 14-1 and the narration data corresponding to the narration request information of the transmission information 14-1.

When the server 12 receives the transmission information 14-2 transmitted from the image printing apparatus 11-2 via the network 13, the server 12 reads the supplementary effect contents requested by the transmission information 14-2, from the plurality of supplementary effect contents stored in the internal memory, then incorporates the read supplementary effect contents into reception information 15-2. The server 12 then transmits or delivers the reception information 15-2 to the image printing apparatus 11-2 via the network 13.

In the example shown in FIG. 1, the reception information 15-1 and the reception information 15-2 are respectively delivered or transmitted to the corresponding image printing apparatus 11-1 or 11-2. However, the server 12 can also transmit the reception information 15-1 and 15-2 to other kinds of apparatus.

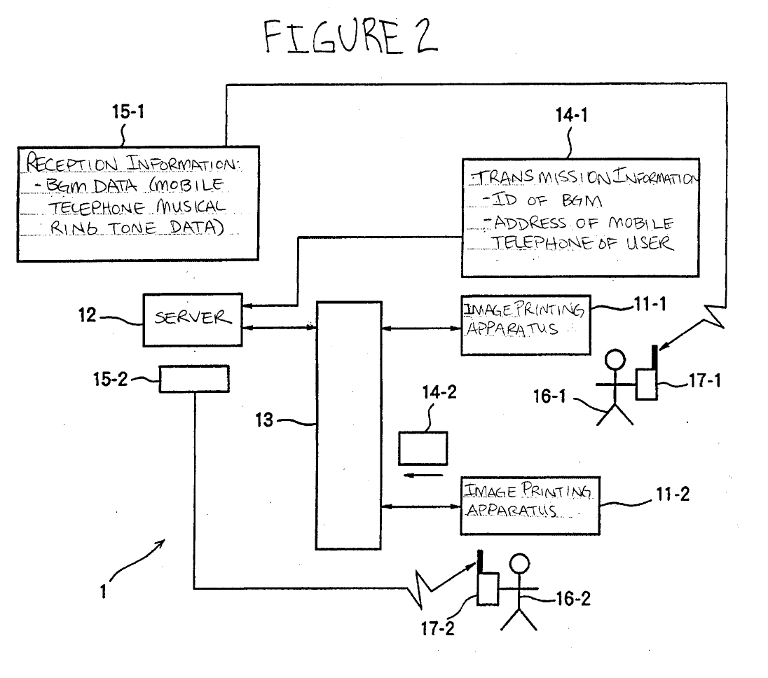

As shown in the exemplary embodiment according to FIG. 2, while a user 16-1 is using the image printing apparatus 11-1, if the user 16-1 desires to use BGM which is outputted from the image printing apparatus 11-1 during seal printing play, as a sound representative of the reception of an incoming call by a mobile telephone 17-1 possessed by the user 16-1 (hereinafter referred to as a mobile-telephone musical ring tone), the user 16-1 causes the image printing apparatus 11-1 to generate the transmission information 14-1 which includes the BGM-ID of the BGM and the address of the mobile telephone 17-1 of the user 16-1 (for example, a mail address or a telephone number). The transmission information 14-1 is transmitted to the server 12 via the network 13.

In this case, when the server 12 receives the transmission information 14-1, the server 12 reads BGM data (mobile-telephone musical ring tone data) corresponding to the BGM-ID included in the transmission information 14-1, from the plurality of BGM data stored in the internal memory, then incorporates the BGM data into the reception information 15-1, and then wirelessly transmits or delivers the reception information 15-1 to the mobile telephone 17-1.

As shown in FIG. 2 by way of example, while a user 16-2 is using the image printing apparatus 11-2, if the user 16-2 desires to use BGM which is outputted from the image printing apparatus 11-2 during seal printing play, as a mobile-telephone musical ring tone for a mobile telephone 17-2, the user 16-2 causes the image printing apparatus 11-2 to generate the transmission information 14-2 which includes the BGM-ID of the BGM and the address of the mobile telephone 17-2 of the user 16-1. The transmission information 14-2 is then transmitted to the server 12 via the network 13.

In this case, when the server 12 receives the transmission information 14-2, the server 12 reads BGM data (mobile-telephone musical ring tone data) corresponding to the BGM-ID included in the transmission information 14-2, from the plurality of BGM data stored in the internal memory, then incorporates the BGM data into the reception information 15-2, and then wirelessly transmits or delivers the reception information 15-2 to the mobile telephone 17-2.

In the following description, the image printing apparatus 11-1 and the image printing apparatus 11-2 will be referred to as an image printing apparatus 11 unless the image printing apparatus 11-1 and the image printing apparatus 11-2 do not need to be distinguished from each other. In addition, in the case where the term “image printing apparatus 11” is used, the transmission information 14-1 or the transmission information 14-2 is called transmission information 14, the reception information 15-1 or the reception information 15-2 is called reception information 15, the user 16-1 or 16-2 is called a user 16, and the mobile telephone 17-1 or the mobile telephone 17-2 is called a mobile telephone 17.

In general, there exist many kinds of copyrighted BGM data such as mobile-telephone musical ring tone data or the like, and in the case of copyrighted BGM data, it is preferable to apply, for example, the following measures for protecting copyrights to such copyrighted BGM data. Namely, it is preferable that, for example, the mobile telephone 17 which receives BGM data be constructed to be incapable of transmitting the BGM data to other mobile telephones.

Specifically, the mobile telephone 17 is capable of transmitting downloaded contents to other mobile telephones generally in the form of attached information which is attached to an E-mail, an exclusive mail or the like. Accordingly, BGM data delivered from the server 12 is constructed as, for example, data incapable of being attached to such a mail. Accordingly, in the case where the BGM data transmitted to the mobile telephone 17 holds a copyright, the BGM data can be prevented from being used free of charge by any party other than the user 16 of the mobile telephone 17 who is a valid user of the BGM data.

Otherwise, it is preferable that when, for example, the mobile telephone 17 which receives the BGM data transmits the BGM data to another mobile telephone, a user of the other mobile telephone which has received the BGM data is charged a fee when the user is to use the BGM data.

Specifically, in this case, the mobile telephone 17 can transmit downloaded BGM data to unspecified other mobile telephones in the form of an attachment to a mail. However, when a user possessing another mobile telephone refers to the attached information (the BGM data), the user is charged the use fee of the user's mobile telephone. Accordingly, users who possess mobile telephones other than the mobile telephone 17, which is the first mobile telephone to receive the BGM data, are charged fees for the BGM data, whereby it is possible to reliably protect the copyright of the BGM data.

Otherwise, the BGM data may be recorded on a recording medium (not shown) to be fitted into the mobile telephone 17, and may be constructed so that when the recording medium on which the BGM data is recorded is fitted into another information processing device, the information processing device cannot reproduce the BGM data from the fitted recording medium. Accordingly, the user 16 of the mobile telephone 17 cannot copy the BGM data (mobile-telephone musical ring tone data) to another information processing device, whereby it is possible to reliably protect the copyright of the BGM data (mobile-telephone musical ring tone data).

In some cases, a copyright holder himself/herself may deliver his/her BMG to a wide range of unspecified users as a mobile-telephone musical ring tone or the like so that the BGM becomes popular or widespread. BGM data corresponding to such BGM may be delivered as BGM data to which none of the above-described measures for protecting copyrights is applied.

The method of delivering the BGM data (the reception information 15) to the user 16 is not limited to the example shown in FIG. 2. For example, the image printing apparatus 11 may be provided with a cable (not shown) for connection to the mobile telephone 17 so that the BGM data is delivered to the mobile telephone 17 when the user 16 connects the cable to the mobile telephone 17 after having inputting the address of the mobile telephone 17 to the image printing apparatus 11.

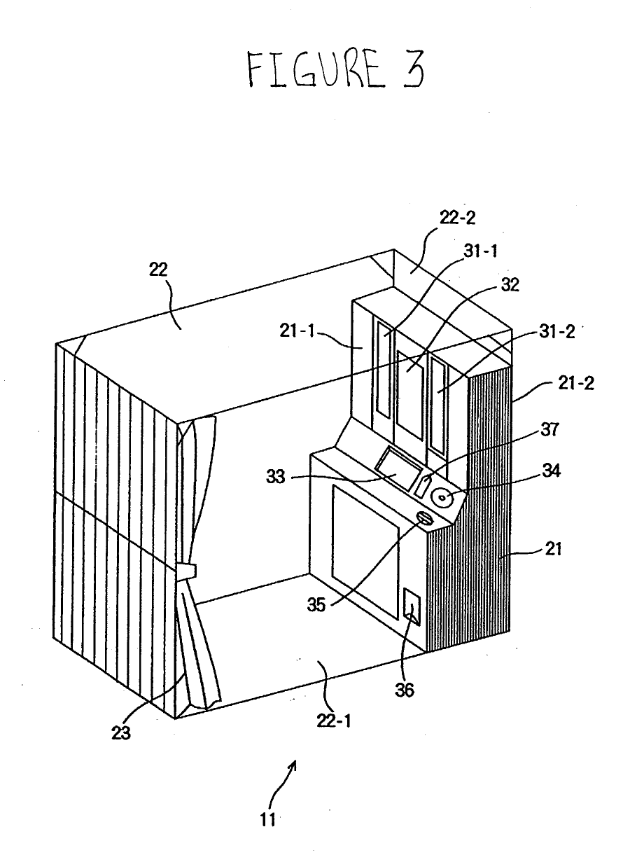

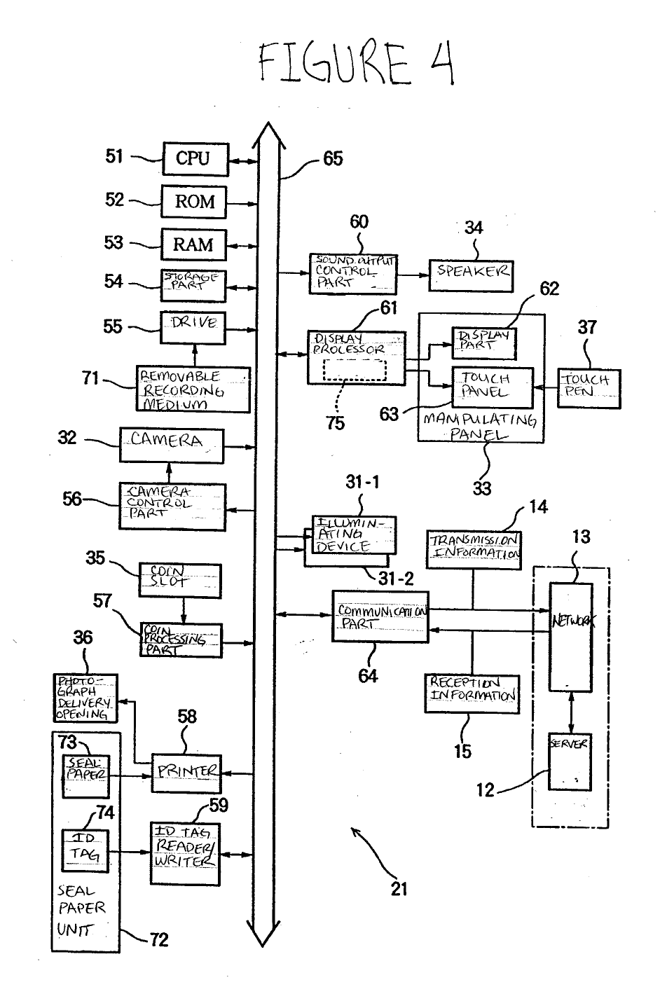

Another embodiment of the image printing apparatus 11 will be described below with reference to FIGS. 3 and 4. FIG. 3 shows an example of the external appearance of the image printing apparatus 11. In the example shown in FIG. 3, the image printing apparatus 11 includes a main body 21, a photographing booth 22 and a curtain 23. The photographing booth 22 may be disposed at a street corner or in a structure such as a building. One side 22-1 of the photographing booth 22 is opened, and the user 16 enters or leaves the photographing booth 22 via the side 22-1.

When the user 16 who has entered the photographing booth 22 is to perform photography, the user 16 covers the opened side 22-1 of the photographing booth 22 with the curtain 23 to shut out light (external light) which enters the photographing booth 22 from outside the booth 22.

Although shown with a booth and curtain, the photographing booth 22 and the curtain 23 may be omitted. In this case, a sheet or other blocking device which shuts out external light is directly fitted to the main body 21.

The main body 21 is disposed in the photographing booth 22 so that a back surface 21-2 (the surface 21-2 opposed to a front surface 21-1) and the inside surface of a side 22-2 perpendicular to the side 22-1 of the photographing booth 22 are brought into contact with each other. A pair of illuminating devices 31-1 and 31-2 are provided in an upper portion of the front surface 21-1 of the main body 21, and a camera 32 for photographing the user 16 in the photographing booth 22 is provided between the pair of illuminating devices 31-1 and 31-2. Camera 32 may include, but is not limited to a Charge Coupled Device (CCD) camera.

When the user 16 is to be photographed with the camera 32, the illuminating device 31-1, 31-2 function as flash units and, even before the start of photography, illuminate the user 16 because when the curtain 23 shuts out external light, the interior of the photographing booth 22 becomes dark.

Further, a manipulating panel 33 and a touch pen 37 may be provided below the camera 32 on the front surface 21-1 of the main body 21. A speaker 34 may be provided on the right side of the touch pen 37 on the front surface 21-1 (on the right side as viewed in FIG. 3).

As shown in FIG. 4, discussed below, the manipulating panel 33 may include a display part 62 made of a liquid crystal display or a Cathode-Ray Tube (CRT) and a touch panel 63 stacked on the top of the display part 62. An image picked up by the camera 32 and selected by the user 16 as an image to be edited (hereinafter referred to as an editing target image as required) is displayed on the manipulating panel 33 (the display part 62).

The user 16 can write (input) arbitrary characters, figures or the like to the editing target image by manipulating the touch pen 37 on the image displayed on the manipulating panel 33 (the display part 62) (i.e., by disposing the tip of the touch pen 37 on the illuminating optical axis 63). Namely, after the user 16 has caused the main body 21 to photograph himself/herself at a location before the front surface 21-1 of the main body 21 (in the photographing booth 22), the user 16 edits a photographed image of himself/herself.

This process in which the user 16 edits a photographed image of himself/herself is hereinafter referred to as “scribbling,” and the processing of the image printing apparatus 11 (the main body 21) that corresponds to the scribbling is referred to as “scribbling processing.” Namely, the scribbling processing is image processing which synthesizes written (scribbled) characters or figures (data) with an editing target image (data) so that the characters or figures are disposed at a location in the editing target image where the characters or figures are scribbled.

In addition to the editing target image, various selecting buttons, messages and the like may be selectively displayed on the manipulating panel 33 (the display part 62) according to the progress of the above-described seal printing play, and a selecting button displayed on the manipulating panel 33 (the display part 62) is selected with, for example, the touch pen 37 (the tip of the touch pen 37 is disposed on the selecting button (the touch panel 63), whereby the seal printing play is made to progress.

Furthermore, a supplementary effect image such as the above-described photographed pose image and an image for explaining the seal printing play are displayed on the manipulating panel 33 (the display part 62) according to the progress of the seal printing play.

In this example, the input devices used are the manipulating panel 33 (the touch panel 63) and the touch pen 37. However, the kinds of input devices are not limited to these examples, and, for example, a hardware button or the like may be used. The speaker 34 outputs to the user 16 a sound such as a narration which guides the progress of the seal printing play, and also outputs BGM or other sound as required while the user 16 is performing the seal printing play. A coin slot 35 is provided below the speaker 34 on the front surface 21-1 of the main body 21, and a photograph delivery opening 36 is provided below the coin slot 35.

The user 16 puts a coin for a predetermined amount of money in the coin slot 35, and starts the seal printing play where the main body 21 of the image printing apparatus 11 starts executing processing corresponding to the seal printing play (hereinafter referred to as seal printing play processing). Subsequently, after the completion of photography, the photographed image (the scribbled image) is printed on a predetermined number of divided seals, and the divided seals are delivered from the photograph delivery opening 36.

FIG. 4 is a block diagram showing a construction example of the interior of the main body 21 of the image printing apparatus 11. In this embodiment, a CPU (Central Processing Unit) 51, a ROM (Read Only Memory) 52 and a RAM (Random Access Memory) 53 are connected to a bus 65. The CPU 51 controls the entire operation of the image printing apparatus 11 (the main body 21) via the bus 65 according to the computer program stored in the ROM 52 or the computer program loaded into the RAM 53 from a storage part 54. The RAM 53 also stores the data or the like required to execute various kinds of processing by CPU 51, at appropriate time. Also connected to the bus 65 are the storage part 54 made of a hard disk or the like, and a communication part 64 which executes communication processing for performing communication with the server 12 via the network 13. Namely, the communication part 64 may transmit the transmission information 14 to the server 12 via the network 13, and receive the reception information 15 transmitted from the server 12 via the network 13.

The reception information 15 received is stored in the RAM 53 or the storage part 54. For example, in the case where the reception information 15 includes a computer program (such as application software), the computer program is installed into the storage part 54 as required. Also connected to the bus 65 are the camera 32, a camera control part 56, a coin processing part 57, a printer 58, an ID tag reader/writer 59, a sound output control part 60, a display processor 61, and the illuminating device 31-1 as well as the illuminating device 31-2.

The camera control part 56 is connected to the camera 32 and, on the basis of the control of the CPU 51, starts and completes the photographing operation of the camera 32 and also appropriately controls the zoom ratio and the amount of exposure of the camera 32.

The coin processing part 57, on the basis of the control of the CPU 51, detects coins put in the coin slot 35 and calculates the total amount of the coins. If the coin processing part 57 determines that the calculated amount has reached a predetermined amount of money which is preset as an image creation fee, the coin processing part 57 notifies the calculated amount to the CPU 51. The CPU 51 starts the above-described seal printing play on the basis of this notification from the coin processing part 57.

The printer 58 is a part which creates an image seal on the basis of the control of the CPU 51. The printer 58 prints an image photographed by the camera 32 and subjected to the above-described scribbling processing (an image defined to be printed (hereinafter referred to as a print image) onto a seal sheet (or seal paper) 73 or the like which is fed from a seal paper unit 72, and outputs (delivers) the printed seal sheet 73 to the photograph delivery opening 36. The printer 58 prints a print image selected by the user 16 onto the seal paper 73 which is divided in specified units. The user 16 can select and print several kinds of print images onto a sheet of the seal paper 73.

The ID tag reader/writer 59 reads an ID tag 74 attached to the seal paper unit 72 and notifies the CPU 51 of the ID read from the ID tag 74. The CPU 51 collates the ID notified from the ID tag reader/writer 59 with the IDs stored in advance in the ROM 52 or the like, and determines whether the seal paper 73 accommodated in the seal paper unit 72 is appropriate for use in the image printing apparatus 11, and sets the image printing apparatus 11 (the main body 21) to an enabled state or to a disabled state.

Namely, if the ID written to the ID tag 74 matches one of the IDs stored in advance in the ROM 52, the CPU 51 enables the main body 21. On the other hand, if the ID written to the ID tag 74 does not match one of the IDs stored in advance in the ROM 52, the CPU 51 disables the main body 21.

Although the external appearance of the seal paper unit 72 is not shown, the seal paper unit 72 is removably secured to the image printing apparatus 11 (the main body 21), and the seal paper 73 is loaded in the interior of the seal paper unit 72 and the ID tag 74 is attached to the seal paper unit 72 at a predetermined position where the ID tag reader/writer 59 can read the ID tag 74. An ID corresponding to the kind of seal paper 73 loaded is written in the ID tag 74 attached to the seal paper unit 72.

There is seal paper dedicated to the mechanism of each type of image printing apparatus. For this reason, users have heretofore often mistakenly loaded a nonconforming type of seal paper (seal paper for a different type of image printing apparatus) into an image printing apparatus. However, in the above-described example, since the ID tag 74 for identifying the seal paper 73 dedicated to the image printing apparatus 11 (the main body 21) is used, the image printing apparatus 11 can identify and print the dedicated seal paper 73. Namely, the ID tag 74 is provided on a mount for the seal paper 73 or on a cartridge or the like which accommodates the mount, so that the dedicated seal paper 73 can be identified. Accordingly, seal paper of good quality can be limitedly used and good finish of printing can be maintained.

Although in this example the ID tag 74 is attached to the seal paper unit 72, the seal paper 73 can be identified by any other method that can identify the kind of seal paper 73 loaded in the seal paper unit 72. For example, instead of the ID tag 74, methods such as bar codes and 1C cards may be used to identify the seal paper 73. Otherwise, different types of seal paper units 72 having different fitting portions may be prepared for individual types of main bodies 21 so that a conforming one of the seal paper units 72 can only be fitted into a particular one of the main bodies 21. In addition, the seal paper 73 and the seal paper unit 72 can also be constructed separably or integrally.

The sound output control part 60, on the basis of the control of the CPU 51, converts sound data transferred from the RAM 53 or the storage part 54, such as a narration for explaining the seal printing play or BGM to be reproduced during the seal printing play, into a sound signal and supplies the sound signal to the speaker 34. The speaker 34 converts the supplied sound signal into a sound and outputs the sound. The speaker 34 outputs the sound corresponding to the sound data supplied to the sound output control part 60.

The display processor 61, on the basis of the control of the CPU 51, stores image data in a built-in memory 75 and displays the image data on the display part 62 of the manipulating panel 33 in the form of an image, the image data being transferred from the RAM 53 or the storage part 54 and corresponding to an image photographed by the camera 32 such as an editing target image or a print image or a supplementary effect image such as a photographed pose image. Namely, the display part 62 displays the image corresponding to the image data supplied to the display processor 61. As described above, the display part 62 may include a liquid crystal display, a CRT or other display means. The display part 62 may also include a projector which projects an image on a screen. The display processor 61 supplies to the CPU 51 coordinate data corresponding to a position detected by the touch panel 63 of the manipulating panel 33 (a position where the tip of the touch pen 37 is disposed).

As described above, on the basis of the control of the CPU 51, the illuminating devices 31-1 and 31-2 function as flash units when the user 16 is to be photographed by the camera 32, and also illuminate the user 16 before the start of photography. In this manner, the image printing apparatus 11 of this example is constructed as a photography seal vending machine which vends photography-printed seals.

In addition, a drive 55 is connected to the bus 65 as required, and a removable recording medium 71 such as a magnetic disk, an optical disk, a magneto-optical disk or a semiconductor memory may be fitted to the drive 55 as required. A computer program read from the removable recording medium 71 may be installed into the storage part 54 as required.

An example of the server 12 will be described below with reference to FIG. 5. A CPU 101 executes various kinds of processing in accordance with a computer program stored in a ROM 102 or a computer program loaded into a RAM 103 from the storage part 107. The RAM 103 also stores the data or the like required for the CPU 101 to execute various kinds of processing. The CPU 101, the ROM 102 and the RAM 103 are connected to one another via a bus 104. An input/output interface 109 is also connected to the bus 104.

Connected to the input/output interface 109 are an input part 105 made of a keyboard or the like, an output part 106 made of a CRT or the like, and the storage part 107 made of a hard disk or the like. In this example, as described above, a plurality of supplementary effect contents are stored in the storage part 107.

A communication part 108 which executes communication processing for performing communication with the image printing apparatus 11 via the network 13 is connected to the input/output interface 109. The communication part 108 receives the transmission information 14 transmitted from the image printing apparatus 11 via the network 13, and transmits or delivers the reception information 15 including supplementary effect contents requested by the transmission information 14, to the image printing apparatus 11 via the network 13.

In addition, a drive 110 is connected to the input/output interface 109 as required, and a removable recording medium 111 such as a magnetic disk, an optical disk, a magneto-optical disk or a semiconductor memory may be fitted to the drive 110 as required, and a computer program read from the removable recording medium 111 may be installed into the storage part 107 as required.

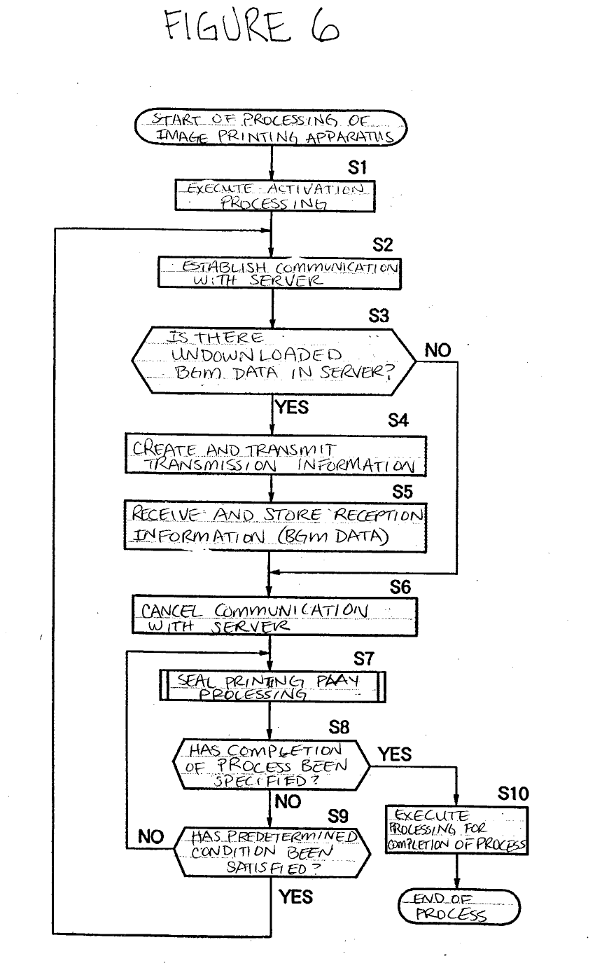

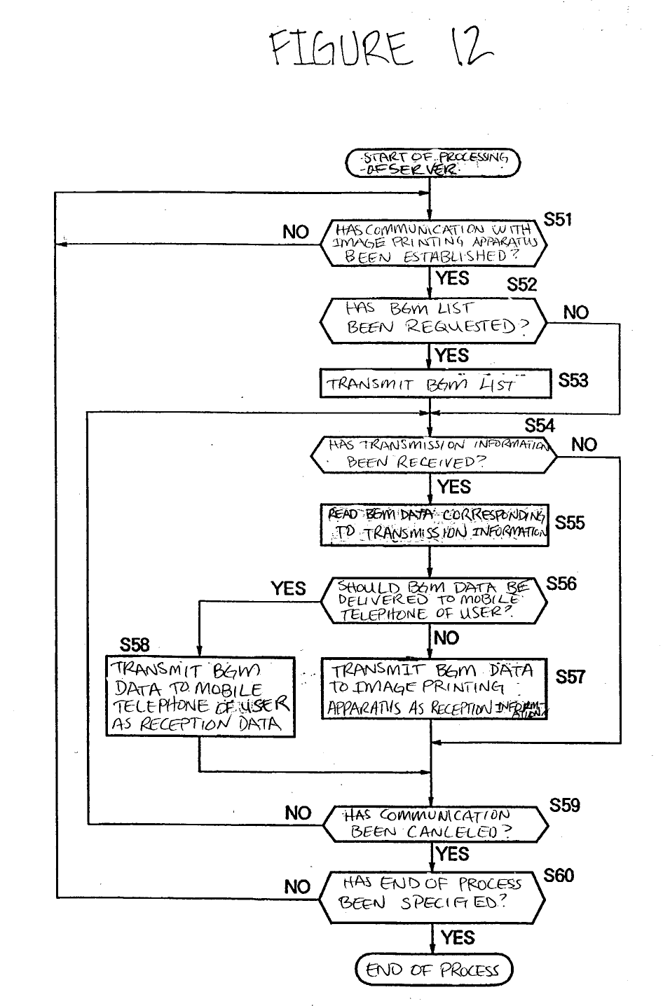

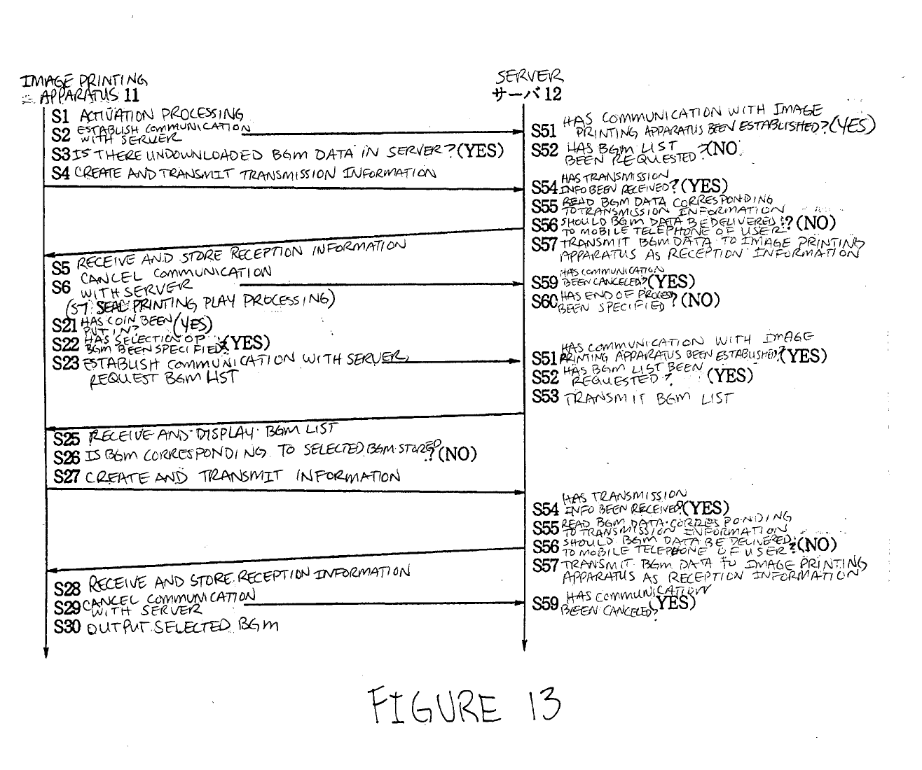

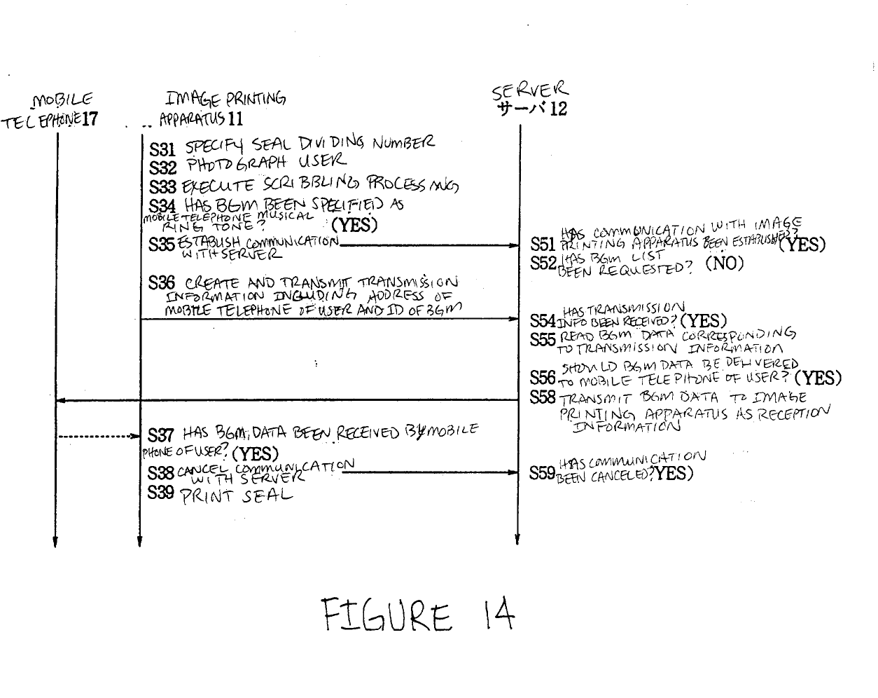

The operation of the image printing system 1 shown in FIG. 1 will be described below with reference to the flowcharts shown in FIGS. 6 to 8 and 12. FIGS. 6 to 8 show the processing of the image printing apparatus 11. FIG. 12 shows the processing of the server 12. FIGS. 13 and 14 are flowcharts showing the relationship between the processing of the image printing apparatus 11 and the processing of the server 12.

The processing of the image printing apparatus 11 and the processing of the server 12 will be individually described below with reference to FIGS. 6 to 8, 12, 13 and 14. The relationship in processing between the image printing apparatus 11 and the server 12 can be easily understood by referring to the corresponding steps shown in FIG. 13 or 14.

In the following description, for the sake of simplicity in description, it is assumed that the server 12 delivers only BGM data to the image printing apparatus 11 or the mobile telephone 17 possessed by the user 16 who uses the image printing apparatus 11. However, the server 12 is capable of delivering various contents in addition to the BGM data, as described above.

First, the processing of the image printing apparatus 11 will be described below with reference to FIG. 6. It is assumed that a manager has just turned on a power source (not shown) of the main body 21 of the image printing apparatus 11 shown in FIG. 3. At this time, in Step SI, the CPU 51 of the main body 21 shown in FIG. 4 executes predetermined activation processing and brings the above-described seal printing play into an executable state. In Step S2, the CPU 51 establishes communication with the server 12 via the communication part 64 and the network 13. Namely, the CPU 51 accesses the server 12. In Step S3, the CPU 51 determines whether BGM data which is not yet downloaded is stored in the server 12.

Specifically, as described above, BGM data are assigned unique IDs (BGM-IDs) for identifying the respective BGM data. Furthermore, in this example, in the case where BGM data is stored in, for example, the storage part 54 or the storage part 107 of the server 12 (FIG. 5), the BGM data and a BGM-ID corresponding to the BGM data are stored in a mutually associated state.

In this example, in Step S3, the CPU 51 detects all the BGM-IDs stored in the storage part 107 of the server 12, via the communication part 64 and the network 13, and determines whether each of the BGM-IDs stored in the storage part 54 matches any one of all the detected BGM-IDs, thereby determining whether BGM data which is not yet downloaded is stored in the server 12.

In Step S3, if the CPU 51 determines that each of all the detected BGM-IDs matches any of the BGM-IDs stored in the storage part 54, the CPU 51 determines that BGM data which is not yet downloaded is not stored in the server 12. Then, the CPU 51 proceeds to Step S6 without executing the processing of Step S4 and S5, and in Step S6, cancels the communication with the server 12 via the communication part 64 and the network 13.

In Step S3, if the CPU 51 determines that at least one of the detected BGM-IDs does not match any of the BGM-IDs stored in the storage part 54, the CPU 51 determines that BGM data which is not yet downloaded is stored in the server 12. A BGM-ID which does not match any of the BGM-IDs stored in the storage part 54 is hereinafter referred to as an undownloaded ID.

Then, in Step S4, the CPU 51 generates the transmission information 14 which requests delivery of BGM data corresponding to the undownloaded ID (the transmission information 14 including the undownloaded ID), and transmits the transmission information 14 to the server 12 via the communication part 64 and the network 13.

As will be described below, when the server 12 receives via the network 13 the transmission information 14 transmitted from the communication part 64 of the image printing apparatus 11, the server 12 reads BGM data corresponding to the undownloaded ID included in the transmission information 14 from the built-in storage part 107 (FIG. 5), and transmits (delivers) the read BGM data to the image printing apparatus 11 via the network 13 as the reception information 15 (Steps S54 to S57 of FIGS. 12 and 13).

At this time, in Step S5, the CPU 51 receives the reception information 15 transmitted from the network 13 (the BGM data corresponding to the undownloaded ID) via the communication part 64, and stores the reception information 15 in the storage part 54. As described above, the CPU 51 stores the undownloaded ID and the BGM data corresponding to the undownloaded ID in the storage part 54 in a mutually associated state. Then, in Step S6, the CPU 51 cancels the communication with the server 12 via the communication part 64 and the network 13. In Step S7, the CPU 51 executes seal printing play processing.

If the CPU 51 determines that a coin for a predetermined amount of money has been put into the coin slot 35, the CPU 51 causes the camera 32 to photograph the user 16, and performs scribbling processing and the like on image data of the user 16, and then causes the printer 58 to perform printing. After that, the CPU 51 delivers the seal paper 73 on which the image of the user 16 has been printed, to the photograph delivery opening 36. On the other hand, if the CPU 51 determines that the coin has not been put into the coin slot 35, the CPU 51 does not execute the above-described series of processing, and causes the process to proceed to Step S8.

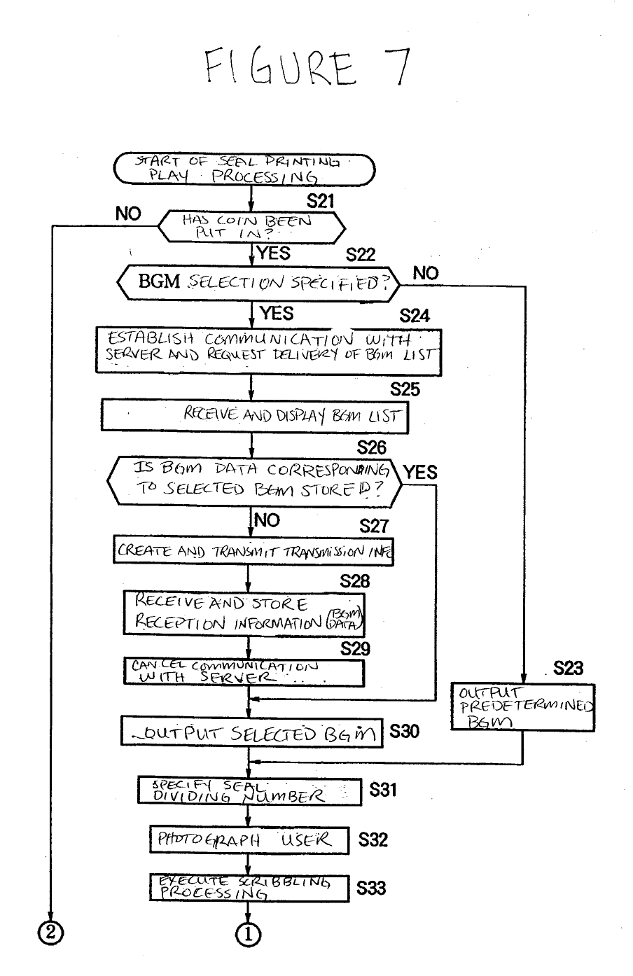

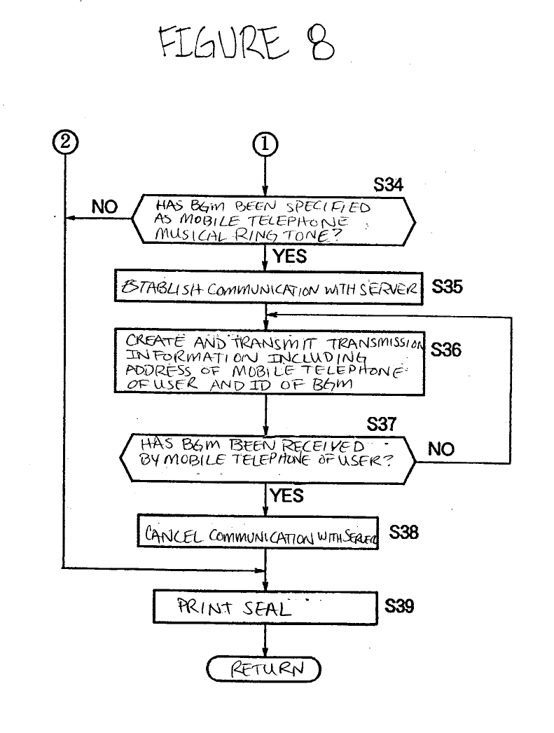

Details of the seal printing play processing of this example (the processing of Step S7) are shown in the flowcharts of FIGS. 8 and 7, and the detailed description of the seal printing play processing will be given later.

In Step S8, the CPU 51 determines whether the completion of the process has been specified, for example by determining whether the power source has been turned off. If the CPU 51 determines that the completion of the process has not been specified, the CPU 51 determines in Step S9 whether a predetermined condition has been satisfied. If the CPU 51 determines in Step S9 that the predetermined condition has not been satisfied, the process returns to Step S7, and the CPU 51 repeats Step S7 and the following steps. If the predetermined condition has not been satisfied and the completion of the process has not been specified, the CPU 51 stands by for the seal printing play processing until a coin is put into the coin slot 35, and when a coin for the predetermined amount of money is put into the coin slot 35, the CPU 51 executes the seal printing play processing.

On the other hand, if the CPU 51 determines in Step S9 that the predetermined condition has been satisfied, the CPU 51 returns the process to Step S2 and repeats Step S2 and the following steps. Namely, not only when the image printing apparatus 11 (the main body 21) is activated, but also when the predetermined condition is satisfied, the CPU 51 determines whether BGM data which is not yet downloaded is stored in the server 12, and if the CPU 51 determines that BGM data which is not yet downloaded is stored in the server 12, the CPU 51 acquires the BGM data from the server 12.

This predetermined condition is not particularly limited. For example, the CPU 51 may start the time counting operation of a timer (not shown) as one process of the activation processing of Step S1, and when a counted time period exceeds a predetermined time period, the CPU 51 can determine that the predetermined condition has been satisfied. In this case, since BGM data which is not yet downloaded is delivered from the server 12 at intervals of a predetermined time period, the image printing apparatus 11 can consistently provide the latest BGM even if the main body 21 is placed in an activated state for a long time.

After that, if, for example, the manager or the like turns off the power source of the main body 21 of the image printing apparatus 11, the CPU 51 determines in Step S8 that the completion of the process has been specified, and Step S10 executes predetermined process completion processing to bring the process to an end.

Details of the seal printing play processing of this example (the processing of Step S7 of FIG. 6) will be described below with reference to FIGS. 7 and 8. First, in Step S21, the CPU 51 determines whether the coin has been put into the coin slot 35, by determining whether the coin processing part 57 has detected the coin.

If the CPU 51 determines in Step S21 that the coin has not been put into the coin slot 35, the CPU 51 returns the process to Step S8 (FIG. 6) and executes Step S8 and the following steps. If the completion of the process is not been specified and the predetermined condition is not been satisfied, the CPU 51 stands by for the seal printing play processing until a coin has been put into the coin slot 35.

When the user 16 puts a coin for the predetermined amount of money into the coin slot 35, the coin processing part 57 detects that the coin for the predetermined amount of money has been put in, and notifies the detected fact to the CPU 51. When the CPU 51 receives the notification (notification indicating that the predetermined amount of money has been put into the coin slot 35), the CPU 51 determines in Step S21 that the coin has been put in, and determines in Step S22 whether selection of BGM has been specified.

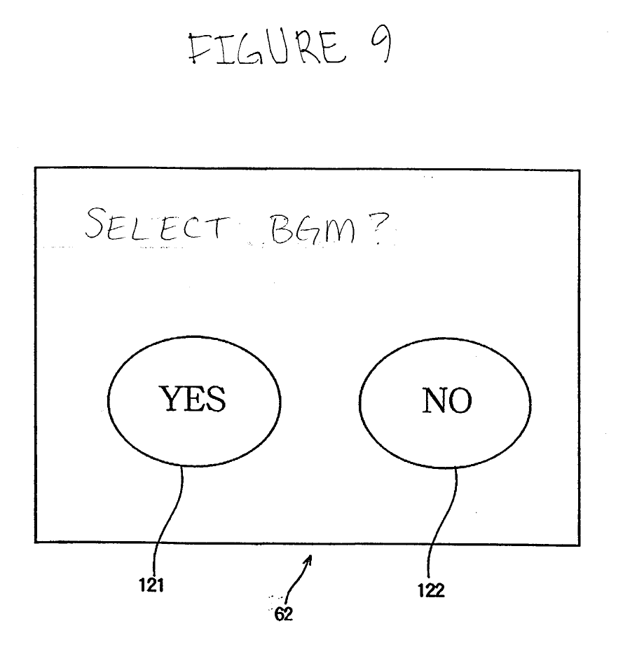

Specifically, in this example, image data corresponding to, for example, the message “SELECT BGM?” shown in FIG. 9 as well as a selecting button displayed as “YES” and a selecting button 122 displayed as “NO” which are stored in the ROM 52 in advance. In this case, if the CPU 51 determines in Step S21 that the coin has been put in, the CPU 51 reads the image data from the ROM 52 and supplies the read image data to the display processor 61. The display processor 61 displays the supplied image data on the display part 62 of the manipulating panel 33 as the image shown in FIG. 9.

Then, if the user 16 decides to select his/her favorite BGM as BGM to be reproduced during the seal printing play, the user 16 manipulates the touch pen 37 to select the “YES” selecting button 121. On the other hand, if the user 16 decides to use preset BGM as BGM to be reproduced during the seal printing play, the user 16 manipulates the touch pen 37 to select the “NO” selecting button 122.

If the user 16 selects the “NO” selecting button 122, the touch panel 63 detects that fact and notifies the detected fact to the CPU 51 via the display processor 61. When the CPU 51 receives the notification indicating that the “NO” selecting button 122 has been selected, the CPU 51 determines in Step S22 that selection of BGM has not been specified, and in Step S23 outputs the predetermined preset BGM to the speaker 34 via the sound output control part 60.

Namely, the CPU 51 reads BGM data corresponding to the predetermined BGM from the storage part 54 or the like, and supplies the read BGM data to the sound output control part 60. The sound output control part 60 converts the supplied BGM data to a sound signal, and supplies the sound signal to the speaker 34. The speaker 34 converts the supplied sound signal into a sound (predetermined BGM) and outputs the sound.

On the other hand, if the user 16 selects the “YES” selecting button 121, the touch panel 63 detects that fact and notifies the detected fact to the CPU 51 via the display processor 61. When the CPU 51 receives the notification (notification indicating that the “YES” selecting button 121 has been selected), the CPU 51 determines in Step S22 that selection of BGM has been specified, and in Step S24 establishes communication with the server 12 (accesses the server 12) via the communication part 64 and the network 13 and requests the server 12 to deliver a BGM list.

As will be described below, when the server 12 is requested to deliver the BGM list via the network 13 by the image printing apparatus 11, the server 12 transmits the BGM list (data) which includes a list of the titles and the like of BGM corresponding to all the BGM data stored in the built-in storage part 107 (FIG. 5), to the image printing apparatus 11 via the network 13 (Steps S51 to S53 of FIGS. 12 and 13).

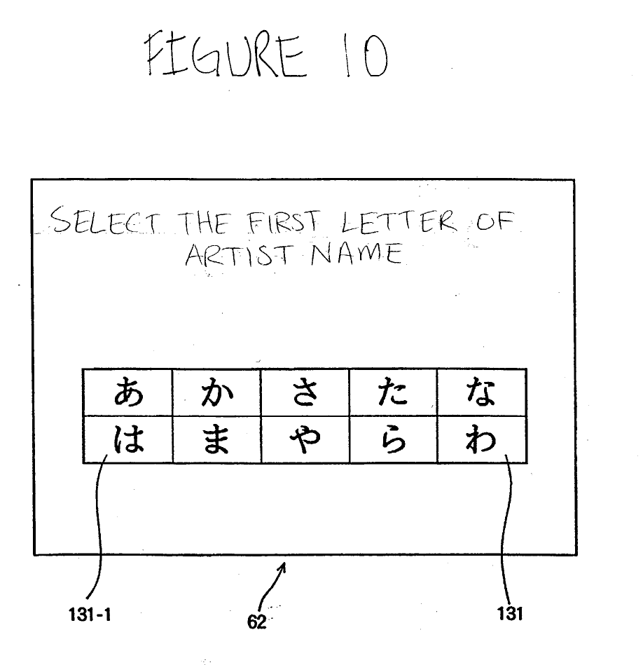

At this time, in Step S25, the CPU 51 receives the BGM list transmitted from the network 13, as data via the communication part 64, and displays the received data on the display part 62 of the manipulating panel 33 via the display processor 75. In this example, an image such as that shown in FIG. 10 (the message “SELECT THE FIRST LETTER OF ARTIST NAME”) and a selecting button group 131 displayed as “A” to “Z” are displayed on the display part 62.

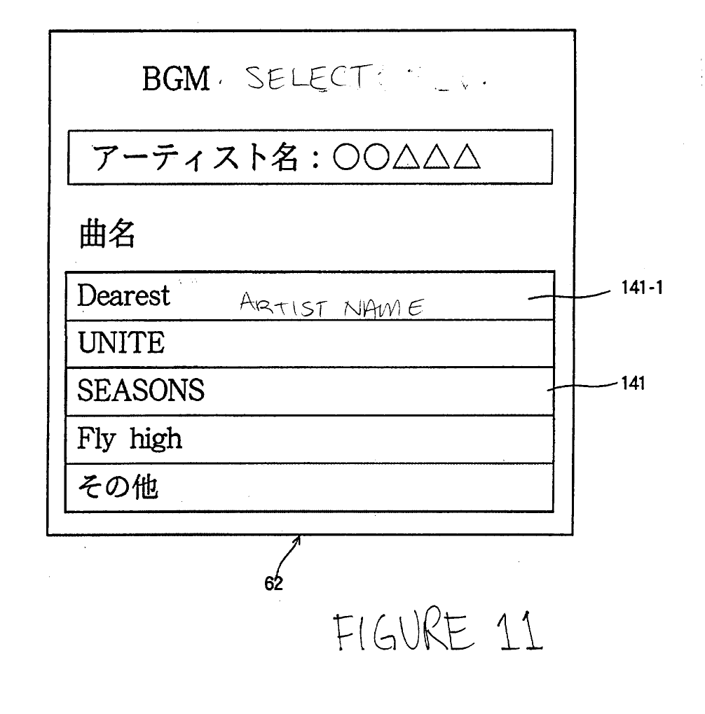

The user 16 may manipulate the touch pen 37 to select from the selecting button group 131 a selecting button on which the desired first letter (any one of the first letters “A” to “Z”) is displayed. For example, if the user 16 manipulates the touch pen 37 to select a selecting button 131-1 displayed as “H”, the touch panel 63 detects that fact and notifies the detected fact to the CPU 51 via the display processor 61. When the CPU 51 receives the notification (notification indicating that the selecting button 131-1 displayed as “H” has been selected), the CPU 51 displays the images shown in FIG. 11. Messages such as “SELECT BGM”, “ARTIST NAME: OOΔΔΔ” and “TITLES”, as well as a selecting button group 141 on which BGM names (titles) may be displayed on the display part 62 via the display processor 61.

It is also preferable that the images shown in FIG. 11, together with the image shown in FIG. 10, be collectively received by the image printing apparatus 11 as one image data set, and be temporarily stored in the RAM 53 or the storage part 54 so that appropriate image data is read from the temporarily stored images and is displayed at a later time. Otherwise, it is also preferable that at the time when the user 16 selects “H”, new data different from the image data shown in FIG. 10 be received by the image printing apparatus 11.

The user 16 manipulates the touch pen 37 to select from the selecting button group 141 the desired selecting button on which the desired music title (the name of the desired BGM) is displayed. For example, if the user 16 manipulates the touch pen 37 to select a selecting button 141-1 on which “Dearest” is displayed, the touch panel 63 detects that fact and notifies the detected fact to the CPU 51 via the display processor 61.

When the CPU 51 receives the notification indicating that the selecting button 141-1 on which “Dearest” is displayed has been selected, the CPU 51 detects an BGM-ID corresponding to the selecting button 141-1 (the ID of BGM titled “Dearest”), and determines in Step S26 whether the detected BGM-ID matches any one of the BGM-IDs stored in the storage part 54, thereby determining whether BGM data corresponding to the selected BGM is stored in the storage part 54.

If a BGM-ID which matches the BGM-ID corresponding to the selecting button 141-1 is stored in the storage part 54, the CPU 51 determines in Step S26 that BGM data corresponding to the selected BGM is stored in the storage part 54, and in Step S30, outputs the selected BGM (the BGM titled “Dearest”) to the speaker 34 via the sound output control part 60.

The CPU 51 reads the BGM data corresponding to the selected BGM (the BGM titled “Dearest”) from the storage part 54, and supplies the read BGM data to the sound output control part 60. The sound output control part 60 converts the supplied BGM data into a sound signal and supplies the sound signal to the speaker 34. The speaker 34 converts the supplied sound signal into a sound (the BGM titled “Dearest”) and outputs the sound.

On the other hand, if the BGM-ID which matches the BGM-ID corresponding to the selecting button 141-1 (the ID of the BGM titled “Dearest”) is not stored in the storage part 54, the CPU 51 determines in Step S26 that BGM data corresponding to the selected BGM is not stored in the storage part 54, and in Step S27, generates the transmission information 14 including the BGM-ID corresponding to the selecting button 141-1 (the ID of the BGM titled “Dearest”), and transmits the transmission information 14 to the server 12 via the communication part 64 and the network 13.

As will be described below, when the server 12 receives the transmission information 14 transmitted from the communication part 64 of the image printing apparatus 11 via the network 13, the server 12 reads from the built-in storage part 107 (FIG. 5) BGM data (BGM data corresponding to the BGM titled “Dearest”) corresponding to the BGM-ID (the BGM-ID corresponding to the selecting button 141-1) included in the transmission information 14, and transmits the read BGM data to the image printing apparatus 11 via the network 13 as the reception information 15 (Steps S54 to S57 of FIGS. 12 and 13).

At this time, in Step S28, the CPU 51 receives the reception information 15 (the BGM data corresponding to the BGM titled “Dearest”) transmitted from the network 13, via the communication part 64, and stores the reception information 15 in the storage part 54. Specifically, as described above, the CPU 51 stores the ID of the BGM titled “Dearest” and the BGM data corresponding to the BGM titled “Dearest” in the storage part 54 in a mutually associated state.

Then, in Step S29, the CPU 51 releases the communication with the server 12 via the communication part 64 and the network 13, and in Step S30, outputs the selected BGM (the BGM titled “Dearest”) to the speaker 34 via the sound output control part 60. The CPU 51 reads the BGM data corresponding to the BGM titled “Dearest” (the BGM data stored in the storage part 54 by the processing of Step S28) from the storage part 54, and supplies the read BGM data to the sound output control part 60. The sound output control part 60 converts the supplied BGM data into a sound signal and supplies the sound signal to the speaker 34. The speaker 34 converts the supplied sound signal into a sound (the BGM titled “Dearest”) and outputs the sound.

In Step S31, the CPU 51 specifies a seal dividing number (a number by which to divide a seal) which has been selected by the user 16. After that, if the user 16 gives an instruction to photograph himself/herself (for example, the user 16 manipulates the touch pen 37 to select a selecting button (not shown) corresponding to a shutter), in Step S32, the camera 32 photographs the user 16 on the basis of the control of the camera control part 56 (the CPU 51).

The CPU 51 stores image data of the photographed user 16 in the RAM 53, and also supplies the image data to the display processor 61. The display processor 61 stores the image data of the user 16 in the built-in memory 75, and displays an image corresponding to the image data of the user 16 on the display part 62 as an editing target image.

In Step S33, the CPU 51 executes the scribbling processing. As described above, the user 16 manipulates the touch pen 37 to write an arbitrary character, figure or the like to the editing target image displayed on the manipulating panel 33 (the display part 62). At this time, the display processor 61 supplies the character or the figure (the coordinates thereof) detected by the touch panel 63 to the CPU 51. The CPU 51 synthesizes the supplied character or figure with the editing target image at a position where the character or figure has been scribbled. The CPU 51 synthesizes data corresponding to the character or the figure with data corresponding to the supplied coordinates in the editing target image data stored in the RAM 53.

This synthesized image data is stored in the RAM 53 (overwritten as an editing target image), and is also supplied to the display processor 61 and an image corresponding to the synthesized image data is displayed on the display part 62.

When the scribbling processing of Step S33 is completed, the CPU 51 defines as the data of a print image the data of the editing target image which is stored in the RAM 53 at this time (the image data of the editing target image subjected to scribbling (the synthesized image).

Then, although not shown, in this example, the CPU 51 displays on the display part 62, for example, the message “Enter your mail address, and the music with which you have just played will be mailed to you as a musical ring tone (a mobile-telephone musical ring tone)”

If the user 16 who has looked at this message desires to use the BGM outputted from the speaker 34 by the execution of the processing of Step S30 of FIG. 7, as a mobile-telephone musical ring tone for the mobile telephone 17 possessed by the user 16 himself/herself, the user 16 manipulates the touch pen 37 within a predetermined time period, to write the mail address of the mobile telephone 17 to a predetermined mail address writing field (not shown) displayed on the manipulating panel 33 (the display part 62).

In this case, in Step S34 of FIG. 8, the CPU 51 determines whether the BGM has been specified as the mobile-telephone musical ring tone. If the mail address of the mobile telephone 17 is not written within the predetermined time period by the user 16, the CPU 51 determines in Step S34 whether the BGM has not been specified as the mobile-telephone musical ring tone.

Then, in Step S39, the printer 58, on the basis of the control of the CPU 51, prints the print image defined by the CPU 51 at the time of the completion of the processing of Step S33 (FIG. 7) onto the seal paper 73 having the number of divided units corresponding to the seal dividing number specified by the CPU 51 in the processing of Step S31 (FIG. 7). The seal paper 73 printed by the printer 58 is delivered from the photograph delivery opening 36 and is provided for the user 16.

On the other hand, if the mail address of the mobile telephone 17 is written within the predetermined time period by the user 16, the CPU 51 detects the main address via the touch panel 63 and the display processor 61, and determines in Step S34 whether the BGM has been specified as the mobile-telephone musical ring tone.

Then, in Step S35, the CPU 51 establishes communication with the server 12 (accesses the server 12) via the communication part 64 and the network 13, and in Step S36, as described above (as shown in FIG. 2), generates the transmission information 14 including the detected address (in this example, the detected mail address) of the mobile telephone 17 of the user 16 and the BGM-ID (the ID of the BGM titled “Dearest”), and transmits the transmission information 14 to the server 12 via the communication part 64 and the network 13.

As will be described below, when the server 12 receives, via the network 13, the transmission information 14 transmitted from the communication part 64 of the image printing apparatus 11, the server 12 reads the BGM data corresponding to the BGM-ID (in this flowchart, BGM data corresponding to the BGM titled “Dearest”) included in the transmission information 14, from the built-in storage part 107 (FIG. 5), and wirelessly transmits (delivers) the read BGM data to the mobile telephone 17 of the user 16 as the reception information 15 (Steps S54 to S56 and S58 of FIGS. 12 and 14).

At this time, the mobile telephone 17 of the user 16 receives the reception information 15 (the BGM data corresponding to the BGM titled “Dearest”) transmitted from the server 12, and stores the reception information 15 in an internal memory (not shown) as mobile-telephone musical ring tone data.

In this example, when the user 16 confirms that the reception information 15 from the server 12 has been received by the mobile telephone 17, the user 16 manipulates the touch pen 37 to select a predetermined button (not shown) displayed on the manipulating panel 33 (the display part 62) in order to notify that fact to the image printing apparatus 11. The CPU 51 determines in Step S37 whether the BGM data has been received by the mobile telephone 17 of the user 16.

If the predetermined button (not shown) is not selected within a predetermined time period by the user 16, the CPU 51 determines in Step S37 that the BGM data is not yet received by the mobile telephone 17 of the user 16, and returns the process to Step S36 and repeats Step S36 and the following steps. Namely, the CPU 51 again transmits the transmission information 14 to the server 12 via the communication part 64 and the network 13.

On the other hand, if the predetermined button (not shown) is selected by the user 16, the CPU 51 detects that fact via the touch panel 63 and the display processor 61, and determines in Step S37 that the BGM data has been received by the mobile telephone 17 of the user 16. In Step S38, the CPU 51 release the communication with the server 12 via the communication part 64 and the network 13.

Then, in Step S39, the printer 58, on the basis of the control of the CPU 51, prints the print image defied by the CPU 51 at the time of the completion of the processing of Step S33 (FIG. 7) onto the seal paper 73 having the number of divided units corresponding to the seal dividing number specified by the CPU 51 in the processing of Step S31 (FIG. 7). The seal paper 73 printed by the printer 58 is delivered from the photograph delivery opening 36 and is provided for the user 16. After that, the process is returned and the processing of Step S8 (FIG. 6) and the following steps are repeated. If the completion of the process is not specified and the predetermined condition is not satisfied, the CPU 51 stands by for the seal printing play processing until a coin is put into the coin slot 35 by the next user.

As described above, the image printing apparatus 11 acquires undownloaded BGM data from the server 12 each time the main body 21 is activated and each time the predetermined condition is satisfied. Accordingly, in the processing of Step S26 of FIG. 7, the CPU 51 rarely determines that no BGM data corresponding to the BGM selected by the user 16 is stored.

The processing of Steps S24 to S29 of FIG. 7 may be omitted to decrease the throughput of the seal printing play of the image printing apparatus 11. However, in this case, the data of the BGM list (the images shown in FIGS. 10 and 11) need to be stored in advance in the storage part 54 or the like.

Otherwise, the processing of Steps S2 to S6 and Step S9 of FIG. 6 may be omitted. In this case, if the main body 21 is activated or if the predetermined condition is satisfied, the image printing apparatus 11 does not acquire the undownloaded BGM data from the server 12. Accordingly, in the processing of Step S26 of FIG. 7, the frequency with which the CPU 51 determines that no BGM data corresponding to the BGM selected by the user 16 is stored may increase. However, since the image printing apparatus 11 does not need to store a large amount of BGM data in the storage part 54 or the like, the amount of memory consumption of the storage part 54 or the like can be reduced.

The processing of the server 12 relative to the processing of the image printing apparatus 11 will be described below with reference to FIG. 12. In Step S51, the CPU 101 shown in FIG. 5 determines whether the server 12 has established communication with the image printing apparatus 11. If the CPU 101 determines that the server 12 has not yet established communication with the image printing apparatus 11, the CPU 101 returns the process to Step S51, in which the CPU 101 again determines whether the server 12 has established communication with the image printing apparatus 11. The CPU 101 consistently monitors the access of the image printing apparatus 11 to the server 12 via the network 13. It is assumed here that, for example, the image printing apparatus 11-1 (FIG. 1) has executed the activation processing in Steps S1 and S2 of FIGS. 6 and 13 as described previously, and has accessed the server 12 via the network 13.

At this time, the CPU 101 determines in Step S51 that the server 12 has established communication with the image printing apparatus 11-1, and determines in Step S52 whether the delivery of the BGM list has been requested.

As described previously, in the case where the image printing apparatus 11-1 accesses the server 12 immediately after the image printing apparatus 11-1 has been activated, the image printing apparatus 11-1 does not request the delivery of the BGM list. Accordingly, the CPU 101 determines in Step S52 that the delivery of the BGM list is not requested, and determines in Step S54 whether the transmission information 14-1 has been received.

If the CPU 101 determines in Step S54 that the transmission information 14-1 has not been received, the CPU 101 determines in Step S59 whether communication has been canceled. If the CPU 101 determines in Step S59 that communication has not been canceled, the CPU 101 returns the process to Step S54 and again determines whether the transmission information 14-1 has been received. The CPU 101 consistently monitors the transmission of the transmission information 14-1 from the image printing apparatus 11-1 via the network 13 until communication is canceled by the image printing apparatus 11-1.

If, as described above, the image printing apparatus 11-1 determines in the processing of Step S3 of FIG. 6 that no undownloaded BGM data is stored in the server 12, the image printing apparatus 11-1 cancels communication with the server 12 in the processing of Step S5. At this time, the CPU 101 determines in Step S54 that the transmission information 14-1 has not been received, and in Step S59, determines that communication has been canceled.

On the other hand, if, as described above, the image printing apparatus 11-1 determines in the processing of Step S3 of FIGS. 6 and 13 that the undownloaded BGM data is stored in the server 12, the image printing apparatus 11-1, in the processing of Step S4, creates the transmission information 14-1 including the undownloaded ID and transmits the transmission information 14-1 to the server 12 via the network 13.

In the example shown in FIG. 1, the transmission information 14-1 includes the photographed pose image request information and the narration request information, but it is assumed here that the transmission information 14-1 includes only the undownloaded ID.

At this time, in Step S54, the CPU 101 receives the transmission information 14-1 via the communication part 108 or determines that the transmission information 14-1 has been received, and in Step S55, reads BGM data corresponding to the transmission information 14-1 (BGM data corresponding to the undownloaded ID) from the built-in storage part 107.

In Step S56, the CPU 101 determines whether the mobile telephone 17-1 of the user 16-1 is a receiver to which to deliver the BGM data. The transmission information 14-1 received at this time (the transmission information 14-1 including only the undownloaded ID) does not include the address of the mobile telephone 17-1 of the user 16-1 such as that shown in FIG. 2. Accordingly, the CPU 101 determines in Step S56 that the mobile telephone 17-1 of the user 16-1 is not a receiver to which to deliver the BGM data, and in Step S57, transmits the BGM data (BGM data corresponding to undownloaded ID) read out in the processing of Step S55 to the image printing apparatus 11-1 as the reception information 15-1 via the communication part 108 and the network 13.

In the example shown in FIG. 1, the reception information 15-1 also includes the photographed pose image request information and the narration request information, but in the flowchart shown in FIG. 12, the transmission information 14-1 does not include information requesting these (includes only the undownloaded ID), so that the transmission information 14-1 does not include any content other than the BGM data corresponding to the undownloaded ID.

As described above, when in processing of step S5 the image printing apparatus 11-1 receives and stores the BGM data corresponding to the transmission information 14-1 (the BGM data corresponding to the undownloaded ID), the image printing apparatus 11-1 cancels communication with the server 12 in the processing of Step S6. At this time, the CPU 101 determines in Step S59 that communication has been canceled, and determines in Step S60 whether the end of the process has been specified.

If the CPU 101 determines in Step S60 that the end of the process has not been specified, the CPU 101 returns the process to Step S51, and repeats Step S51 and the following steps. The CPU 101 again monitors the access of the image printing apparatus 11 to the server 12.

It is assumed here that, for example, the user 16-1 subsequently puts a coin for the predetermined amount of money into the coin slot 35 of the image printing apparatus 11-1 (FIG. 3), and manipulates the touch pen 37 to select the selecting button 121 (the “YES” selecting button 121) from the images displayed on the manipulating panel 33 (the display part 62) as shown in FIG. 9.

In this case, the image printing apparatus 11-1 determines that the coin has been put in and selection of BGM has been specified in the processing of Steps S21 to S23 of FIGS. 7 and 13 as described previously, and starts to access the server 12 via the network 13 and requests delivery of a BGM list.

At this time, the CPU 101 determines in the processing of Step S51 that the server 12 has established communication with the image printing apparatus 11-1, and determines in the processing of Step S52 that delivery of a BGM list has been requested, and in the processing of Step S53, reads the BGM data (data) from the storage part 107 and transmits the BGM data to the image printing apparatus 11-1 via the communication part 108 and the network 13.

The image printing apparatus 11-1 receives the data of the BGM list (for example, the images shown in FIGS. 10 and 11) the transmitted from the communication part 108 of the server 12 and displays the BGM list (the images) on the display part 62 (FIG. 4) in the processing of Step S25 of FIGS. 7 and 13 as described previously.

Then, when predetermined BGM is selected by the user 16-1, the image printing apparatus 11 determines whether BGM data corresponding to the selected BGM is stored as described previously, in the processing of Step S26 of FIGS. 7 and 13. If the image printing apparatus 11-1 determines that no BGM data corresponding to the selected BGM is stored, the image printing apparatus 11-1, in the processing of Step S27, creates the transmission information 14-1 which requests the BGM data (the transmission information 14-1 including the ID of the BGM selected by the user 16-1), and transmits the transmission information 14-1 to the server 12 via the network 13.

At this time, in Step S54, the CPU 101 receives the transmission information 14-1 via the communication part 108 (the CPU 101 determines that the transmission information 14-1 has been received), and in Step S55, reads from the storage part 107 BGM data corresponding to the transmission information 14 (BGM data corresponding to the ID of the BGM selected by the user 16-1).

In Step S56, the CPU 101 determines whether the mobile telephone 17-1 of the user 16-1 is a receiver to which to deliver the BGM data. The transmission information 14-1 received at this time (the transmission information 14-1 including only the ID of the BGM selected by the user 16-1) does not include the address of the mobile telephone 17-1 of the user 16-1 such as that shown in FIG. 2. Accordingly, the CPU 101 determines in Step S56 that the mobile telephone 17-1 of the user 16-1 is not a receiver to which to deliver the BGM data, and in Step S57, transmits the BGM data (BGM data corresponding to BGM ID selected by the user 16-1) read out in the processing of Step S55 to the image printing apparatus 11-1 as the reception information 15-1 via the communication part 108 and the network 13.

As described above, when the image printing apparatus 11-1 receives and stores the reception information 15-1 (the BGM data corresponding to the ID of the BGM selected by the user 16-1) in the processing of Step S28 of FIGS. 7 and 13, the image printing apparatus 11-1 cancels communication with the server 12 in the processing of Step S29. At this time, the CPU 101 determines in Step S59 that communication has been canceled, and determines in Step S60 whether the end of the process has been specified. If the CPU 101 determines in Step S60 that the end of the process has not been specified, the CPU 101 returns the process to Step S51, and repeats Step S51 and the following steps.

After that, as described previously, the image printing apparatus 11-1 outputs BGM corresponding to the received reception information 15-1 (the BGM selected by the user 16-1) in the processing of Step S30 of FIGS. 7 and 13, and sets the seal dividing number in the processing of Steps S31 to S33 of FIGS. 7 and 14, and photographs the user 16-1 and executes the scribbling processing.

As described above, if the user 16-1 desires to use the BGM outputted from the image printing apparatus 11-1, as a mobile-telephone musical ring tone for the mobile telephone 17-1 possessed by the user 16-1, the user 16-1 inputs the mail address of the mobile telephone 17-1 to the image printing apparatus 11-1.

In this case, in the processing of Steps S34 to S36 of FIGS. 8 and 14, the image printing apparatus 11-1 determines that the BGM has been specified as the mobile-telephone musical ring tone, and establishes communication with the server 12 (accesses the server 12) and generates and transmits the transmission information 14-1 which includes the inputted address of the mobile telephone 17 of the user 16 and the ID of the BGM which has been outputted, to the server 12 via the network 13.

At this time, in the processing of Step S51, the CPU 101 determines that the server 12 has established communication with the image printing apparatus 11-1, and in the processing of Step S52, determines that the delivery of a BGM list has not been requested. Then, in the processing of Step S54, the CPU 101 determines that the transmission information 14-1 has been received (the CPU 101 receives the transmission information 14-1).

Then, the CPU 101 in Step S55 reads BGM data corresponding to the transmission information 14-1 (mobile-telephone musical ring tone data for the mobile telephone 17-1 possessed by the user 16-1) from the storage part 107, and determines in Step S56 whether the mobile telephone 17-1 of the user 16-1 is a receiver to which to deliver the BGM data.

The transmission information 14-1 received at this time (the transmission information 14-1 shown in FIG. 2) includes the address (mail address) of the mobile telephone 17-1 of the user 16-1. Accordingly, the CPU 101 determines in Step S56 that the mobile telephone 17-1 of the user 16-1 is a receiver to which to deliver the BGM data, and in Step S58, wirelessly transmits the BGM data read out in the processing of Step S55 (the mobile-telephone musical ring tone data for the mobile telephone 17-1 of the user 16-1) to the mobile telephone 17-1 of the user 16-1 as the reception information 15-1.

As described above, the user 16-1 confirms that the BGM data (the mobile-telephone musical ring tone data for the mobile telephone 17-1 of the user 16-1) has been received by the mobile telephone 17, and when the user 16-1 notifies that fact to the image printing apparatus 11-1 (the user 16 manipulates the touch pen 37 (FIG. 3) to select a predetermined button (not shown)), the image printing apparatus 11-1 determines in the processing of Steps S37 and S38 of FIGS. 8 and 14 that the BGM data has been received by the mobile telephone 17-1 of the user 16-1, and cancels communication with the server 12.

At this time, the CPU 101 determines in Step S59 that communication has been canceled, and determines in Step S60 whether the end of the process has been specified. If the CPU 101 determines in Step S60 that the end of the process has not been specified, the CPU 101 returns the process to Step S51, and repeats Step S51 and the following steps. On the other hand, if the CPU 101 determines that the end of the process has been specified, the CPU 101 brings the process to an end.

Although the processing of the server 12 relative to the image printing apparatus 11-1 has been described above, the processing of the server 12 relative to the image printing apparatus 11-2 may also execute the same process. In addition, the processing of the server 12 relative to the image printing apparatus 11-1 and the processing of the server 12 relative to the image printing apparatus 11-2 are executed independently of each other. Namely, the server 12 can deliver contents (the reception information 15-1 and the reception information 15-2), respectively, to the image printing apparatus 11-1 and to the image printing apparatus 11-2 in parallel (at the same time).

In this manner, in the image printing system 1 (FIG. 1), the image printing apparatus 11 and the server 12 are connected to each other via the network 13, and the server 12 timely (frequently) delivers the latest BGM (sound data) to the image printing apparatus 11. Accordingly, the user 16 can consistently enjoy seal printing play with the image printing apparatus 11 while listening to the latest BGM.

In addition, as described above, the supplementary effect contents to be delivered to the image printing apparatus 11 or the mobile telephone 17 (FIG. 2) are not limited to BGM data, and may be various supplementary effect contents such as the latest narrations (sound data) and popular photographic poses (image data), for example. Another example may include a kinetic image for introducing a photographic pose and the kinetic image may include an image for publicizing a predetermined commercial item. The user 16 can enjoy seal printing play with the image printing apparatus 11 while using these various supplementary effect contents.

A manager or the like of the server 12 which delivers the kinetic image may collect advertising expenses from a seller that sells the commercial item. Accordingly, it is possible to create and deliver the kinetic image at reduced creation costs. For example, advertising information for advertising the predetermined commercial item may be displayed in the background of the kinetic image, or a person appearing in the kinetic image for showing a sample of a pose may wear clothes on which advertising information is displayed (sewed), or may also wear or have the commercial item itself which is being publicized. In this manner, the manager or the like of the server 12 may collect advertising expenses from the seller of the commercial item but not collect a delivery fee for the contents of the kinetic image from the manager of the image printing apparatus 11.

Accordingly, the manager or the like of the image printing apparatus 11 can update the contents of the kinetic image without spending high expenses and much time, and can consistently provide the latest kinetic image contents for the user 16. The user 16 can consistently perform seal printing play using the latest kinetic image contents, and can also assume a pose according to the kinetic image and photograph himself/herself with the pose, whereby the user 16 can enjoy active and new seal printing play which is amusing to the user 16.

In addition, the contents to be delivered to the image printing apparatus 11 or the mobile telephone 17 are not limited to the supplementary effect contents. For example, the contents may be contents to be added to a print image, or may also be a computer program such as application software for reproducing the supplementary effect contents (such as sound data and image data). In this case, the image printing apparatus 11 becomes able to easily reproduce even supplementary effect contents which need to be reproduced by a special reproducing method (a new reproducing method).

In addition, the contents may be contents such as wallpaper or a game. The game is not limited to a particular kind, and may be a game of any kind that has a gambling feature such as pachinko, a slot machine or sugoroku, for example. In this case, such a game is delivered to the mobile telephone 17 (FIG. 2) used by the user 16, and if the user 16 performs the game and wins a bet or scores a high point, the server 12 can give the user 16 a privilege (for example, the privilege of free acquisition of BGM data (mobile-telephone musical ring tone data) for one music title).

In addition, since the user 16 can select the desired supplementary effect contents (for example, the desired music title (BGM)), each user 16 can enjoy seal printing play with the image printing apparatus 11 while using different supplementary effect contents (supplementary effect contents suited to the taste of each user 16).

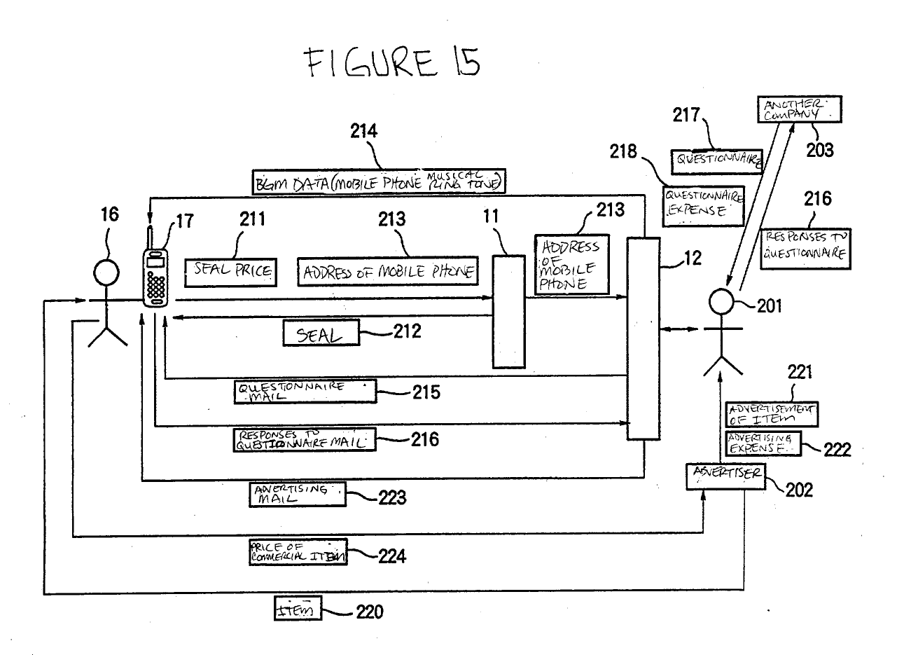

In addition, if the user 16 desires to use BGM which is output from the image printing apparatus 11 during seal printing play, for example as a mobile-telephone musical ring tone for the mobile telephone 17 possessed by the user 16 himself/herself, the image printing apparatus 11, on the basis of an instruction from the user 16, notifies the address (such as a mail address) of the mobile telephone 17 and the ID of the BGM to the server 12. The server 12 then wirelessly transmits BGM data corresponding to the notified BGM-ID (the data of the BGM which the user 16 desires to use as a mobile-telephone musical ring tone for the mobile telephone 17) to the mobile telephone 17 having the notified address (the mobile telephone 17 possessed by the user 16). Accordingly, the business model shown in FIG. 15 by way of example can be realized.

Referring now to FIG. 15, when the user 16 pays a seal price 211 to the image printing apparatus 11 and acquires a seal 212 on which an image of the user 16 is printed, if the user 16 desires to use BGM which was being reproduced during the seal printing play, as a music ring tone for the mobile telephone 17 possessed by the user 16, the user 16 inputs an address 213 of the mobile telephone 17 to the image printing apparatus 11. Then, the image printing apparatus 11 transmits the address 213 of the mobile telephone 17 to the server 12 managed by a contents provider 201, and the server 12, in response to the address 213, transmits BGM data (a mobile-telephone musical ring tone) 214 corresponding to the BGM desired by the user 16 to the mobile telephone 17 of the user 16. In this manner, the contents provider 201 can automatically acquire the mail address of the mobile telephone 17 possessed by the user 16 using the image printing apparatus 11.

In addition, the contents provider 201 may manipulate the server 12 to transmit a questionnaire mail 215 to a plurality of mail addresses acquired in the above-described manner (the mail addresses of the mobile telephones 17 possessed by the users 16 using the image printing apparatus 11). The user 16 creates a response 216 to the questionnaire mail 215 (an answer to the questionnaire) and transmits the response 216 to the transmitter of the questionnaire mail 215 (the server 12) as a mail. In this manner, the contents provider 201 can efficiently and easily search the taste of the user 16 using the image printing apparatus 11.

Specifically, one who desires to perform a predetermined search (such as an questionnaire) has heretofore used a search method which searches for the tastes of a multiplicity of unspecified users by using direct mails or the like and extracts the search results of target users from all the search results. As a result, efficient searches have been difficult to perform.

As an example, a majority of users 16 using the image printing apparatus 11 shown in FIG. 15 may be, for example, girls of primary-school to high-school age. One who desires to perform a search for this category (for example, an questionnaire) (in the above-described example, the contents provider 201) can acquire the addresses 213 of the mobile telephones 17 transmitted to the server 12, thereby searching for the tastes of only users 16 (i.e., the girls of primary-school to high-school age) who possess the mobile telephones 17 corresponding to the acquired addresses 213 of the mobile telephones 17. Accordingly, the contents provider 201 itself can sell the search results obtained in this manner or can use the search results for the development of products to be newly manufactured.

Furthermore, as shown in FIG. 15, if the contents provider 201 receives a request for a questionnaire 217 from another company 203, the contents provider 201 manipulates the server 12 to create the questionnaire mail 215 corresponding to the questionnaire 217, and can transmit the questionnaire mail 215 to a plurality of mail addresses (the mail addresses of the mobile telephones 17 possessed by the users 16 using the image printing apparatus 11). Then, when the contents provider 201 acquires the responses 216 to the questionnaire 217 of the questionnaire mail 215 via the server 12, the contents provider 201 can provide the responses 216 to the questionnaire 217 for the company 203 in exchange of questionnaire expense 218.

Specifically, the company 203 can also efficiently and easily search for the tastes of the users 16 using the image printing apparatus 11, via the contents provider 201, and the contents provider 201 can collect the questionnaire expense 218 from the company 203 as the price of the search performed in place of the company 203 by the contents provider 201.

Furthermore, as shown in FIG. 15, if the contents provider 201 receives a request for an advertisement 221 for a predetermined commercial item 220 from an advertiser 202 selling the commercial item 220 and collects an advertisement expense 222 from the advertiser 202. The contents provider 201 then manipulates the server 12 to create an advertising mail 223 corresponding to the advertisement 221 for the commercial item 220 and transmits the advertising mail 223 to a plurality of mail addresses (the mail addresses of the mobile telephones 17 possessed by the users 16 using the image printing apparatus 11).

Accordingly, the user 16 who sees the advertising mail 223 by manipulating the mobile telephone 17 can buy the commercial item 220 publicized by the advertising mail 223, from the advertiser 202 in exchange of the payment of a price 224 of the commercial item 220. The advertiser 202 can efficiently target advertisements for the commercial item 220 to the users 16 using the image printing apparatus 11. In particular, the effect of the advertisement increases for the commercial item 220 intended, for example, for girls of the above-described age group.

In addition, the manager or the like of the image printing apparatus 11 may make a predetermined contract with the manager of the server 12 as to the service of providing the server 12 with the addresses of the mobile telephones 17 acquired by the image printing apparatus 11 and as to the service of delivering BGM data from the server 12 to the image printing apparatus 11 (for example, a contract to provide free of charge the service of delivering BGM data from the server 12 and to provide free of charge the addresses of the mobile telephones 17 from the image printing apparatus 11). In this case, the manager or the like of the image printing apparatus 11 can consistently provide the latest BGM data without spending expenses and time to update BGM data.

Accordingly, the user 16 can consistently use the latest BGM to perform seal printing play, and further can use the BGM as a mobile-telephone musical ring tone for the mobile telephone 17 possessed by the user 16 himself/herself.

As described above, the server 12 can provide the information held therein to not only the image printing apparatus 11 and the mobile telephone 17 but also other apparatus. For example, the image printing apparatus 11 may also be constructed so that the address of the server 12 (for example, the URL (Uniform Resource Locator) of a home page on the server 12 managed by the manager of the server 12) is made open to the user 16 after the completion of his/her seal printing play using the image printing apparatus 11. The address of the server 12 is displayed on the manipulating panel 33 shown in FIG. 3. According to this embodiment, the user 16 who has seen the address can access the server 12 at a later time by using an information processing device connectable to the network (Internet) 13, and can directly acquire various information (information such as the above-described various supplementary effect contents and application software for reproducing such contents) from the server 12.

In addition, the manager of the server 12 can acquire various information such as the taste of the user 16 from the user 16 who has accessed the server 12. Incidentally, the information processing device used by the user 16 is not particularly limited, and can use any type of device that can access the server 12, such as a personal computer or a Personal Digital Assistant (PDA).

The computer program which executes the above-described series of processing may be installed from the network 13 or a recording medium. This recording medium may include the removable recording medium 71 or 111 on which the computer program is recorded and which, as shown in FIG. 4 or 5, is distributed separately from the image printing apparatus 11 to provide the computer program for an owner of the image printing apparatus 11 and is used in the state of being fitted in the drive 55 or 110. The removable recording medium 71 or 111 may include a magnetic disk (including a floppy disk), an optical disk (including a Compact Disk-Read Only Memory (CD-ROM) or a Digital Versatile Disk (DVD), a magneto-optical disk (including an MD (Mini-Disk)), a semiconductor memory, or other recording media. In addition, the recording medium may also include the ROM 52 or 102 on which the computer program is recorded, a hard disk included in the storage part 54 or 107, or other similar media of the types which are provided for a user in the state of being previously incorporated in the image printing apparatus 11.

The step of writing a computer program to be recorded on the recording medium may include processing which is performed in a time-series manner along the sequence described herein, and may also include processing which is not necessarily processed in a time-series manner but is executed in parallel or separately.

The term “system” used herein represents the entire equipment made of a plurality of apparatus and processing parts.

As is apparent from the foregoing description, according to the image printing system of the invention, it is possible to realize a system which photographs a user and prints an image of the photographed user and can provide the printed image for the user. In particular, it is possible to realize a system which can provide different supplementary effect contents for a plurality of users as amusement effects suited to the tastes of the respective users during the period from the moment when the users are photographed until the moment when images of the photographed users are printed and the printed images are provided for the users.

According to the image printing apparatus of the invention, it is possible to photograph a user, print an image of the photographed user and provide the printed image for the user. In particular, it is possible to provide different supplementary effect contents for a plurality of users as amusement effects suited to the tastes of the respective users during the period from the moment when the users are photographed until the moment when images of the photographed users are printed and the printed images are provided for the users.

According to an information delivering apparatus embodiment of the invention, it is possible to also deliver contents. Particularly in the case of an image printing apparatus which performs the processing of photographing a user, printing an image of the photographed user and providing the printed image for the user, it is possible to deliver to the image printing apparatus supplementary effect contents which have amusement effects suited to the tastes of a plurality of individual users and are to be outputted while the processing is being performed by the image printing apparatus.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modifications, though presently unforeseeable, of the present invention that come within the spirit and scope of the following claims should be considered part of the present invention.

What is claimed is:

1. An image printing system comprising:
an image printing apparatus including a photographing unit for photographing a subject and a printing unit for printing an image of the subject photographed by the photographing unit; and
an information delivering apparatus for delivering information to the image printing apparatus,
the image printing apparatus and the information delivering apparatus being connected to one another via a network,
the image printing apparatus requesting the information delivering apparatus via the network to deliver the information to the image printing apparatus,
the information delivering apparatus delivering the information requested by the image printing apparatus to the image printing apparatus via the network.

2. An image printing system according to claim 1, wherein during a period when the image printing apparatus causes the photographing unit to photograph the subject and causes the printing unit to print an image of the subject photographed by the photographing unit, the image printing apparatus outputs the information delivered from the information delivering apparatus, independently of processing performed by the photographing unit and the printing unit.

3. An image printing method for an image printing system comprising the steps of:
providing an image printing apparatus including a photographing unit for photographing a subject and a printing unit for printing an image of the subject photographed by the photographing unit and an information delivering apparatus for delivering information to the image printing apparatus, the image printing apparatus and the information delivering apparatus being connected to one another via a network;
causing the image printing apparatus to request the information delivering apparatus via the network to deliver the information to the image printing apparatus; and
causing the information delivering apparatus to deliver the information requested by the image printing apparatus to the image printing apparatus via the network.

4. An image printing apparatus comprising:
a photographing unit for photographing a subject;
a printing unit for printing an image of the subject photographed by the photographing unit;
a creating unit for creating request information for requesting delivery of information from an information delivering apparatus connected to the image printing apparatus via a network;
a transmitting unit for transmitting the request information created by the creating unit to the information delivering apparatus via the network;
a receiving unit for receiving via the network the information which is transmitted by the information delivering apparatus and corresponds to the request information transmitted by the transmitting unit; and
an outputting unit for outputting the information received by the receiving unit.

5. The image printing apparatus according to claim 4, wherein during a period when the subject is photographed by the photographing unit and an image of the subject photographed by the photographing unit is printed by the printing unit, the outputting unit outputs the information received by the receiving unit, independently of processing performed by the photographing unit and the printing unit.

6. The image printing apparatus according to claim 4, wherein the creating unit creates the request information for requesting delivery of image data and wherein the outputting unit further comprises a display unit for displaying an image corresponding to the image data received by the receiving unit and which corresponds to the request information.

7. The image printing apparatus according to claim 6, wherein the image data is image data that is different from an image to be printed by the printing unit.

8. The image printing apparatus according to claim 7, wherein the image data is image data corresponding to a kinetic image.

9. The image printing apparatus according to claim 7, wherein an image corresponding to the image data includes an image for publicizing a predetermined commercial item.

10. The image printing apparatus according claim 4, wherein the creating unit creates the request information for requesting delivery of sound data and wherein the outputting unit further comprises a sound outputting unit for outputting a sound corresponding to the sound data which is received by the receiving unit and which corresponds to the request information.

11. The image printing apparatus according claim 4, further comprising an executing unit for executing a computer program which is received by the receiving unit and corresponds to request information for requesting the computer program, wherein when the creating unit creates the request information, the outputting unit outputs the information, and whereby when the computer program is executed by the executing unit, the information is output corresponding to a function executed by the computer program.

12. The image printing apparatus according to claim 4, further comprising a storage unit for storing the information received by the receiving unit and the creating unit, when a predetermined condition is satisfied, creates the request information for requesting delivery of the information not yet stored in the storage unit.

13. The image printing apparatus according to claim 12, wherein the creating unit creates the request information for requesting delivery of information not yet in the storage unit when the image printing apparatus is activated.

14. The image printing apparatus according to claim 13, wherein the creating unit creates the request information for requesting delivery of the information not yet stored in the storage unit each time a predetermined time elapses.

15. The image printing apparatus according to claim 4, further comprising a specifying unit for specifying the information delivered by the information delivering apparatus, wherein the specifying unit creates the request information for requesting delivery of the information specified by the specifying unit.

16. The image printing apparatus according to claim 4, wherein the information delivered by the information delivering apparatus has a unique identifier (ID), wherein the creating unit creates the request information including the ID corresponding to the information for requesting delivery and the receiving unit receives the information corresponding to the ID transmitted by the information delivering apparatus and included in the request information.

17. The image printing apparatus according to claim 4, wherein the creating unit creates the request information for requesting the information to be delivered to an information processing apparatus possessed by a user using the image printing apparatus.

18. The image printing apparatus according to claim 17, wherein the information processing apparatus possessed by the user is a mobile telephone, the information requested by the request information being sound data corresponding to a sound previously outputted to the user by the outputting unit, the information being used by the mobile telephone as sound data corresponding to a sound indicative of reception of an incoming call.

19. An image printing apparatus according to claim 4, further comprising:
a reading unit for reading identification information for identifying a printing medium which is fitted in the image printing apparatus and on which the image of the subject is to be printed by the printing unit; and
a printing controlling unit for controlling printing on the printing medium on the basis of a result read by the reading unit.

20. The image printing apparatus according to claim 19, wherein the printing medium is a seal and the image printing apparatus is a photography seal vending machine.

21. The image printing apparatus according to claim 19 wherein said printing medium unit stores the printing medium on which the image of the subject is to be printed by the printing unit, and holds identification information to be read by the reading unit.

22. An image printing method for an image printing apparatus comprising:
a creating step of creating request information for requesting delivery of information from an information delivering apparatus connected to an image printing apparatus via a network;
a transmitting step of transmitting the request information created by processing of the creating step, to the information delivering apparatus via the network;
a receiving step of receiving via the network the information which is transmitted by the information delivering apparatus and corresponds to the request information transmitted by processing of the transmitting step; and
an outputting controlling step of controlling outputting of the information received by processing of the receiving step.

23. A program for a computer which controls an image printing apparatus comprising:
providing a photographing unit for photographing a subject and a printing unit for printing an image of the subject photographed by the photographing unit, the program causing the computer to execute steps including:
a creating step of creating request information for requesting delivery of information from an information delivering apparatus connected to the image printing apparatus via a network;
a transmitting step of transmitting the request information created by processing of the creating step, to the information delivering apparatus via the network;
a receiving step of receiving via the network the information which is transmitted by the information delivering apparatus and corresponds to the request information transmitted by processing of the transmitting step; and
an outputting controlling step of controlling outputting of the information received by processing of the receiving step.

24. An information delivering apparatus comprising:
said information delivering apparatus connected via a network to an image printing apparatus which includes a photographing unit for photographing a subject and a printing unit for printing an image of the subject photographed by the photographing unit, further including:
a storage unit for storing information delivered to the image printing apparatus;
a receiving unit for receiving via the network request information for requesting delivery of information, the request information being transmitted by the image printing apparatus;
an acquiring unit for acquiring the information corresponding to the request information received by the receiving unit, from the information stored in the storage unit; and
a transmitting unit for transmitting the information acquired by the acquiring unit to the image printing apparatus via the network.

25. The information delivering apparatus according to claim 24, wherein the information is image data different from an image to be printed by the printing unit of the image printing apparatus.

26. The information delivering apparatus according to claim 25, wherein the image data is image data corresponding to a kinetic image.

27. The information delivering apparatus according to claim 25, wherein an image corresponding to the image data includes an image for publicizing a predetermined commercial item.

28. The information delivering apparatus according to claim 24, wherein the information is sound data.

29. The information delivering apparatus according to claim 24, wherein the information is a computer program.

30. The information delivering apparatus according to claim 24, wherein the information stored in the storage unit has a unique identifier (ID), the receiving unit receives the request information including the ID corresponding to the information which is transmitted by the image printing apparatus and whose delivery is requested by the image printing apparatus, and the acquiring unit acquires the information corresponding to the ID included in the request information received by the receiving unit from the information stored in the storage unit.

31. The information delivering apparatus according to claim 24, wherein the receiving unit receives the request information for requesting the information to be delivered to an information processing apparatus possessed by a user using the image printing apparatus, the acquiring unit acquires the information corresponding to the request information received by the receiving unit from the information stored in the storage unit, and the transmitting unit further transmits the information acquired by the acquiring unit to the information processing apparatus possessed by the user.

32. The image printing apparatus according to claim 31, wherein the information processing apparatus possessed by the user is a mobile telephone, the information requested by the request information being sound data previously transmitted to the image printing apparatus by the transmitting unit, the information being used by the mobile telephone as sound data corresponding to a sound indicative of reception of an incoming call.

33. The information delivering apparatus according to claim 32, wherein the information transmitted to the mobile telephone by the transmitting unit is constructed to be disabled from being transmitted when the mobile telephone which has received the information is to transmit the information to another information processing apparatus.

34. The information delivering apparatus according to claim 32, wherein the information transmitted from the transmitting unit to the mobile telephone is constructed so that in the case where the mobile telephone which has received the information transmits the information to another information processing apparatus and a user who uses said another information processing apparatus is charged a fee when the another information processing apparatus which has received the information uses the information.

35. The information delivering apparatus according to claim 32, wherein the information transmitted from the transmitting unit to the mobile telephone is recorded on a recording medium to be fitted into the mobile telephone, and is constructed so that in the case where the recording medium on which the information is recorded is fitted in another information processing apparatus, the information is disabled from being reproduced when the another information processing apparatus is to reproduce the information from the recording medium.

36. An information delivering method for an information delivering apparatus comprising:
providing said information delivering apparatus connected via a network to an image printing apparatus which includes a photographing unit for photographing a subject and a printing unit for printing an image of the subject photographed by the photographing unit;
a storage controlling step of controlling storage of information delivered to the image printing apparatus;
a receiving step of receiving via the network request information for requesting delivery of information, the request information being transmitted by the image printing apparatus;
an acquiring step of acquiring the information corresponding to the request information received by processing of the receiving step, from the information whose storage is controlled by processing of the storage controlling step; and
a transmitting step of transmitting the information acquired by processing of the acquiring step to the image printing apparatus via the network.

37. A program for a computer which controls an image delivering apparatus comprising:
providing said image delivering apparatus connected via a network to an image printing apparatus including a photographing unit for photographing a subject and a printing unit for printing an image of the subject photographed by the photographing unit, wherein said computer program includes the following steps:
a storage controlling step of controlling storage of information delivered to the image printing apparatus;
a receiving step of receiving via the network request information for requesting delivery of information, the request information being transmitted by the image printing apparatus;
an acquiring step of acquiring the information corresponding to the request information received by processing of the receiving step, from the information whose storage is controlled by processing of the storage controlling step; and
a transmitting step of transmitting the information acquired by processing of the acquiring step to the image printing apparatus via the network.
